(19) United States
(12) Patent Application Publication
(10) Pub. No.: US 2008/0141125 A1
(43) Pub. Date: Jun. 12, 2008

(54) Combined data entry systems

(76) Inventor: Firooz Ghassabian, Great Neck, NY (US)

Correspondence Address: SOFER & HAROUN LLP., 317 MADISON AVENUE, SUITE 910, NEW YORK, NY, 10017, US

(21) Appl. No.: 11/821,594

(22) Filed: Jun. 22, 2007

Related U.S. Application Data
(60) Provisional application No. 60/816,397, filed on Jun. 23, 2006.
(60) Provisional application No. 60/819,811, filed on Jul. 10, 2006.
(60) Provisional application No. 60/837,950, filed on Aug. 15, 2006.
(60) Provisional application No. 60/843,522, filed on Sep. 8, 2006.
(60) Provisional application No. 60/856,869, filed on Nov. 3, 2006.
(60) Provisional application No. 60/859,028, filed on Nov. 13, 2006.
(60) Provisional application No. 60/874,039, filed on Dec. 8, 2006.
(60) Provisional application No. 60/877,715, filed on Dec. 28, 2006.
(60) Provisional application No. 60/897,807, filed on Jan. 26, 2007.
(60) Provisional application No. 60/901,132, filed on Feb. 13, 2007.
(60) Provisional application No. 60/901,978, filed on Feb. 16, 2007.
(60) Provisional application No. 60/902,383, filed on Feb. 20, 2007.
(60) Provisional application No. 60/903,571, filed on Feb. 26, 2007.
(60) Provisional application No. 60/906,178, filed on Mar. 9, 2007.
(60) Provisional application No. 60/906,491, filed on Mar. 12, 2007.
(60) Provisional application No. 60/918,656, filed on Mar. 16, 2007.
(60) Provisional application No. 60/919,340, filed on Mar. 21, 2007.
(60) Provisional application No. 60/920,376, filed on Mar. 26, 2007.
(60) Provisional application No. 60/923,733, filed on Apr. 16, 2007.
(60) Provisional application No. 60/927,941, filed on May 4, 2007.

(51) Int. Cl. G06F 17/21

(52) U.S. Cl. 715/261

(57) ABSTRACT

A data entry system having a plurality of a first type of input means, such as keys, to provide input signals to which symbols, such at least the letters of the alphabet of at least one language, are distributively assigned, and such that at least two of the letters are assigned to at least one of the input means, and wherein pressing a key may provide a first input information that ambiguously correspond to any of the letters and a second input information for supporting using a second type of input means for entering unambiguous letters, and wherein the data entry system supports at least one database of words such that in order to enter a desired word of said at least one database, a user of said system selects one or two input methods.

### RELATED APPLICATIONS

This application claims priority to the following U.S. Provisional patent applications: U.S. Provisional Patent Application 60/816,397, filed on Jun. 23, 2006; U.S. Provisional Patent Application 60/819,811, filed on Jul. 10, 2006; U.S. Provisional Patent Application 60/837,950, filed on Aug. 15, 2006; U.S. Provisional Patent Application 60/843,522, filed on Sep. 8, 2006; U.S. Provisional Patent Application 60/856,869, filed on Nov. 3, 2006; U.S. Provisional Patent Application 60/859,028, filed on Nov. 13, 2006; U.S. Provisional Patent Application 60/874,039, filed on Dec. 8, 2006; U.S. Provisional Patent Application 60/877,715, filed on Dec. 28, 2006; U.S. Provisional Patent Application 60/897,807, filed on Jan. 26, 2007; U.S. Provisional Patent Application 60/901,132, filed on Feb. 13, 2007; U.S. Provisional Patent Application 60/901,978, filed on Feb. 16, 2007; U.S. Provisional Patent Application 60/902,383, filed on Feb. 20, 2007; U.S. Provisional Patent Application 60/903,571, filed on Feb. 26, 2007; U.S. Provisional Patent Application 60/906,178, filed on Mar. 9, 2007; U.S. Provisional Patent Application 60/906,491, filed on Mar. 12, 2007; U.S. Provisional Patent Application 60/918,656, filed on Mar. 16, 2007; U.S. Provisional Patent Application 60/919,340, filed on Mar. 21, 2007; U.S. Provisional Patent Application 60/920,376, filed on Mar. 26, 2007; U.S. Provisional Patent Application 60/923,733, filed on Apr. 16, 2007; and U.S. Provisional Patent Application 60/927,941, filed on May 4, 2007, the entirety of which are incorporated herein by reference.

This application is also related to prior PCT Patent Application Nos. PCT/US00/29647, filed on Oct. 27, 2000; PCT/US02/22385, filed on Jul. 12, 2001; PCT/US04/12082, filed on Apr. 19, 2004; PCT/US05/19582, filed on Jun. 3, 2005; and PCT/US/2006/23524 filed on Jun. 16, 2006 the entirety of which are incorporated herein by reference.

### FIELD OF THE INVENTION

The present invention is related to data entry. More particularly, the present invention is directed to a data entry system with features for entering data using an improved method of prediction and key press/glide voice interaction. The invention also relates to a data entry system using ambiguous key presses and unambiguous key presses/handwriting-characters combined with predictive word entry system. The present invention also describes different methods of correction/replacement of the words proposed by the system to provide an extremely accurate and simple data/text entry system.

### BACKGROUND

Typical systems and methods for electronically entering characters include the use of standard keyboards such a QWERTY keyboard and the like. However, as modern electronic devices have become smaller, new methods have been developed in order to enter desired characters.

On such method is to use a multi-press system on a standard telephonic numeric keypad, whereby multiple alphanumeric characters are assigned to the same key. One drawback with such a system is that it requires multiple pressing of single keys in order to enter certain characters, thereby increasing the overall number of key presses, slowing the character entry process.

A second method to accommodate the entering of characters on the ever smaller devices has been to simply miniaturize the standard QWERTY keypad onto the devices. However, such miniaturized keypads are often clumsy and do not afford sufficient space between the keys, causing multiple key presses when only a single press is desired.

Another method for entering text in devices is word predictive system. Such systems are generally capable of entering the words available within the word database of the system. Entering other words, single letters, numbers, punctuation mark characters, etc. becomes frustrating and time consuming through such systems. In addition if the system proposes a non-desired word, selecting a desired word may become frustrating because the system considers all of the words corresponding to the user's key presses.

Yet another attempt to accommodate the entering of characters on smaller electronic devices, is the use of voice recognition software. Such methods have been in use for some time, but suffer from a number of drawbacks. Most notably, voice recognition software suffers from the inability to distinguish homonyms, and often requires significant advance input for the system to recognize a particular speaker, their mannerisms and speech habits. Also, voice recognition software, in attempting to alleviate these problems, has grown large and requires a good deal of processing, not particularly suitable for the limited energy and processing capabilities of smaller electronic devices, such a mobile phones and text pagers.

### OBJECTS AND SUMMARY

As such it is an object of the present invention to provide an improvement over the previously disclosed data entry systems by providing additional enhanced features for predicting and disambiguation using various input means including improved keypads, prediction and voice technologies, among other devices. Furthermore, it is an object of the preset invention to provide an improved data entry prediction and key press/glide with speech (e.g. voice, lip reading) and/or other additional data entry systems helping to better/faster recognize a word through the predictive data entry systems of the invention Even further, it is object of the present invention to improve upon the correction capabilities in such data entry systems.

To this end, the present invention, among other embodiments is drawn to a data entry system having a plurality of input receiving means for at least entering arbitrary characters, where each receiving means is assigned more than one character, such that a user uses the input receiving means to enter a desired input.

A second input receiving means for receiving a second input, where the second input is a precise character or characters from the desired input; wherein the system provides a predictive output based on input from at least said plurality of input receiving means. If the predictive output is different from the desired input and a (e.g. the first) letter of the desired input is different than the first letter of the predictive output, the user may enter a predefined correction signal to provide a precise (first) character of the desired input, such that the system may provide a second predictive output based on the previously provided input from the user and the correction signal. The present invention also describes different simple methods of correction of the words proposed by the system to provide an extremely accurate and simple data/text entry system.

### BRIEF DESCRIPTION OF THE DRAWINGS

In the drawings, in which like reference characters denote similar elements throughout the several views:

FIG. 1 shows (part of) an exemplary keypad and part of a dictionary of words, of the invention in accordance with one embodiment of the invention;

FIG. 2 illustrates four keys of an exemplary keypad of the invention based on a lip reading version of the data entry system, in accordance with one embodiment of the invention;

FIG. 3 shows one example distribution of letters of a language to four keys of an exemplary keypad of the invention FIGS. 4-4a show two examples of distribution of letters of a language to four keys of an exemplary keypad of the invention

FIG. 5 shows a remapping system of the letters of a key of a keypad on other keys (of the keypad) accordance with one embodiment of the invention;

FIG. 5a. shows a remapping system of the letters of a (hard) key of a keypad on on-screen keys on a device accordance with one embodiment of the invention;

FIG. 6 shows (part of) an exemplary keypad and part of a dictionary of words, of the invention in accordance with one embodiment of the invention;

FIG. 7 shows an exemplary keypad having different mode keys and part of a dictionary of words, of the invention in accordance with one embodiment of the invention

FIG. 8 shows an exemplary keypad and part of a dictionary of words, of the invention in accordance with one embodiment of the invention

FIG. 9 shows an exemplary keypad and part of a dictionary of words, of the invention in accordance with one embodiment of the invention;

FIG. 10 shows a device having an exemplary keypad of the invention (including ambiguous letter keys) and a QWERTY keyboard having unambiguous keys to demonstrate a method of data entry system of the invention (that may not require speech)

FIGS. 11-11c show a remapping system of the letters of a key of a keypad on other keys (of the keypad) accordance with one embodiment of the invention;

FIG. 12 shows an exemplary electronic device (e.g. PC) having an exemplary keypad of the invention (including ambiguous letter keys) and a split QWERTY keyboard (having unambiguous keys to demonstrate a method of data entry system of the invention (that may not require speech)

FIG. 13 shows an exemplary electronic device (e.g. PDA) having an exemplary keypad of the invention (including ambiguous letter keys) and a QWERTY keyboard (having unambiguous keys to demonstrate a method of data entry system of the invention (that may not require speech)

FIGS. 14-14D shows an exemplary electronic device (e.g. phone) having a telephone-type keypad wherein at least some of its keys duplicate the keys of a keypad of the invention to demonstrate a method of data entry system of the invention

FIG. 15 shows a keyboard of the invention such as that shown in FIG. 10 used as an external data entry unit of (mobile) electronic devices FIGS. 16A-16D show an exemplary remapping system of the characters of the keys of a keypad on other keys (of the keypad) accordance with one embodiment of the invention;

FIG. 17 shows an exemplary electronic device (e.g. phone) having a keypad of the invention for entering ambiguous key presses and a telephone-type keypad for entering precise characters to demonstrate a method of data entry system of the invention

FIGS. 18-18B show a multi-modal electronic device (e.g. phone/data oriented device) including the data entry system of the invention, in accordance with one embodiment of the invention;

FIG. 19 shows an exemplary electronic device (e.g. phone) having a keypad of the invention for entering ambiguous key presses and a telephone-type keypad for entering precise characters to demonstrate a method of data entry system of the invention

### DETAILED DESCRIPTION

Certain previously described features for data entry, such as those from the incorporated references, show a data entry system for entering at least arbitrary characters/text, using a (e.g. keypad having) reduced number of (e.g. hard, soft, virtually duplicated, etc.) keys has been described before. The data entry system may use a number of symbols comprising at least the letters of the alphabet of at least one language and wherein the symbols may distributedly be assigned to the keys such that at least two of the letters may be assigned to at least one key.

In these systems an (e.g. predefined) interaction such as a pressing action on a key may, ambiguously, correspond to any of the symbols/letters assigned to the key (e.g. the key may be called “ambiguous key”). As described before, for example, in order to enter one of the symbols (e.g. such as a letter) assigned to a key, the user may provide a predefined interaction with the key such as a pressing action on the key and provide a speech information corresponding to the symbol (e.g. such as speaking (e.g. the appellation of) the letter) for selecting the symbol (e.g. letter among the symbols (e.g. letters) that are assigned to the key, and wherein the speech information may be detected and analyzed based on at least one of, the user's voice and/or the user's lips movements.

It must be noted that the number of symbols may includes substantially all of the elementary symbols, such as alphanumeric characters, punctuation marks, and commands for either the input or editing of a text or the manipulation of a computer. For example, in order to enter a punctuation mark character, the user may press on a corresponding key and speak the character. Other symbols such as macros, portion-of-a-words, etc, may also distributedly be assigned to (e.g. (e.g. different predefined interactions with) the reduced number of keys).

According to one previously disclosed method, the absence of speech may also be considered as the speech information, and wherein at least one of the symbols assigned to a key may be entered by providing the predefined interaction with the key in the absence of a speech, the absence of speech being detected by the system. For example, in order to enter a predefined punctuation mark character assigned to a key, the user may predefinely press the key corresponding to the character without speaking.

According to one method, the reduced number of keys may duplicate a telephone-type keypad. The letter assignment may resemble to the letter assignment of the telephone-type keypad.

According to another method, the system may use a reduced number of keys (e.g. a keypad) wherein the letters of the alphabet may be assigned to at least some of the keys such as four keys of the reduced number of keys. Reduced number of keys to be used with data entry systems of the invention have been described in detail in the patent applications incorporated by reference here.

According to one method symbols such as letters having ambiguously resembling predefined speech and that are hard to distinguish from each other through their corresponding speech may separately from each other being assigned to different keys or to different predefined interactions with a same key.

Also other related input technologies such the entry of at-least-a-portion-of-a-word (e.g. portion-by-portion data entry system using press/glide action on one or more corresponding keys combined with the corresponding speech information (e.g. the absence of speech may also be predefinely considered as a speech information)) have been described in detail. Also as mentioned in the previous patent applications, other data entry systems such as full (e.g. hard, soft/on-screen) PC keyboards and/or handwriting recognition systems, may be combined/used with the (e.g. press and speak) data entry systems of the invention to input a text/data.

Also as mentioned in the previous patent applications, based on the data entry methods, derivative enhanced data entry systems have been considered and described before. For example, the data entry systems (e.g. providing precise characters) may be combined with the principles of a word predictive system (e.g. based on pressing actions on ambiguous keys corresponding to the characters/letters of a word and using a database of, words and corresponding key presses information of each word. The principles of such word predictive system is known by people skilled in the art. (e.g. T9)) to provide a highly quick and accurate data/text entry system using (e.g. very) few keys (e.g. wherein obviously at least some of the keys are ambiguous keys as described before), (e.g. and minimizing user's interactions such minimizing user's speech or user's interaction for selecting a word among candidate words). As mentioned previously, for example, by using the press-and-speak data entry system of the invention the user may provide at least one precise character of a word and press the (e.g. ambiguous) keys corresponding to the remaining characters of the word to enter the word. By considering the at least one precise character of a the word, and considering the key presses corresponding to the remaining characters of the word, the system more accurately may predict the corresponding word.

As mentioned before, the press/glide and speech information (e.g. with/without speaking) data entry systems of the invention may be combined with other data entry systems such as a word predictive system based on key-presses provided on a keypad (e.g. T9). The principles of the word predictive systems based on key presses (e.g. only), are known by people skilled in the art. Also as mentioned before, a word of a language may be entered by using the press/glide and speak data entry systems of the invention for entering precisely at least one of the (e.g. preferably, the beginning) letters (e.g. or characters (a word may include characters other than letters, too)) of the word and providing key presses only (without speaking) corresponding to other letters (e.g. or characters) of the word. For example, for entering the word “ball”, by using a telephone keypad, a user may enter a beginning letter (e.g. “b”) of the word by pressing a key corresponding to the letter and providing a speech corresponding to the letter, and (e.g. then) press the keys corresponding to other letters (e.g. in this example, chain of characters “all”) of the word without speaking. In this example, providing a sequence of key presses only (e.g. without speaking) for (e.g. corresponding to) all of the letters (including the letter “b”) of the word “ball” may also correspond to the word “call”. But because in the above-mentioned example, the beginning letter “b” is precisely entered, the system does not consider the word “call). According to another example, for entering the word “home” by using the same keypad, the user may first press the keys corresponding to the beginning letters “ho” without speaking. He then may press the key corresponding to the next letter “m” and speak the letter (e.g. precisely entering the letter). Then the user may press the key corresponding to the last letter “e” without speaking. The sequence of key presses may also correspond to the word “gone”, but because the system has precisely recognized that the third letter of the desired word is the letter “m”, then the word “home” will be selected/entered.

As mentioned before, by (e.g. considering a first type of information consisting of) providing precisely at least a (e.g. beginning) letter/character of a word and (e.g. combined with considering at least a second type of information consisting of) providing the remaining key presses (e.g. key presses corresponding the remaining characters of the word), in most cases the system may find a single corresponding (e.g. desired) word within its dictionary of words that match the combined information. In this example, by precisely entering the letter “b”, the system selects the word “ball” without the need of further user's interaction (e.g. such as pressing on a “Select” key to scroll over different choices).

It must be noted that according to one method, the user may provide the key presses corresponding to the letters of a word and speak any of the letters during the key presses even if the user's speech is not synchronized (e.g. is not provided simultaneously) with the corresponding key press(es).

Also as mentioned before, according to one embodiment of the invention, a user may provide the key presses corresponding to the letters of a word and speak the word.

As known by people skilled in the art and described before, the word predictive systems based on key press information use at least a dictionary of words and a corresponding key presses database.

According to one embodiment of the invention, during the entry of a text, the user may enter a word (e.g. a word existing in the dictionary, an out-of-dictionary word, a chain of characters that does not exist in the dictionary of words, etc.) by providing the key presses corresponding to the letters/characters of the word and providing the speech information corresponding to the (e.g. letters of) the word. On the other hand, if the user desires, he may enter a word existing in the dictionary by entering (e.g. providing) the corresponding key presses (e.g. providing key presses only, corresponding to the letters of a word may correspond to a large number of a words (e.g. choices) within the database of the words of the system). For better accuracy and minimizing the number of the choices for example, while pressing the beginning (e.g. and/or middle, and/or last) key(s) of the word, the user may speak the beginning (e.g. and/or middle, and/or last) letter(s) of the word (e.g. as mentioned before, providing the key press and the speech corresponding to at least one of the letters of a word, may enter, precisely, the at least one letter (as is described later in this patent application, other methods may be used for entering one or more precise characters/letters of a word during the entry of said word through the word predictive data entry systems of the invention). Therefore, by considering the at least one precise letter and the key presses corresponding to the remaining characters of the word the number of the choices (e.g. candidate words) may dramatically be reduced. (e.g. hereafter in many paragraphs this system combining different (e.g. including the predictive) methods of data entry just described, may be mentioned as “combined” data entry system(s) (of the invention)). Throughout the application, such systems may be referred to as a “combined data entry system” or rather simply “data entry system (of the invention)”, such terms being used interchangeably in the context of the present invention unless specifically recited otherwise.

The basic premise of such combined data entry systems have been described previously such as in the references incorporated herein, filed by this inventor, The embodiments of the present invention constitute systems and methods for enhancing such combined data entry systems and the correction methods to for example replace a proposed word by the system by a new words based on additional input information provided by the user through the correction procedures of the invention. This application also provides additional enhancements, derivatives, applications, etc., to the data entry systems of the invention.

The press-and-speak data entry systems of the invention permitting the entry of text by combining the at-least-a-portion-of a word data entry methods (e.g. mentioned as portion-by-portion data entry system of the invention) have been described in detail in previous patent applications filed by this inventor). According to one embodiment of the word predictive data entry systems of the invention, instead of entering a single character, a user may enter a-portion-of-a-word by using a press/glide and speech data entry system of the invention for entering precisely at least a (e.g. beginning) portion of the word and provide key presses only (e.g. without speaking) corresponding to other letters of the word. For example, in order to enter the word “predefined”, the user may enter the portion “pre” by a pressing/gliding action on corresponding key(s) of the keypad and speak the portion, and then press on the keys corresponding to the remaining letters “defined” of the word, without speaking. Obviously, during the key pressing actions corresponding to the remaining characters of the word, if desired the user may provide the speech corresponding to at least some of the characters (e.g. speaking the letters) corresponding the corresponding key presses to precisely enter the at least some of the characters.

According to one embodiment of the invention (although the accuracy of the system may be reduced), for entering a precise (e.g. unambiguous) character/portion-of-a-word/word the user may speak said character/portion-of-a-word/word without providing the (e.g. corresponding) key pressing action. Accordingly, for entering a word through a word predictive method of the invention, the user may enter at least one precise character of the word by speaking said at least one character without pressing the key(s) corresponding to said at least one character, and (e.g. then) press the keys corresponding to the other characters of said word without speaking. For example, for entering the word “ball”, by using a telephone type keypad, a user may enter a beginning letter (e.g. “b”) of the word by speaking the letter “b” (e.g. without pressing a corresponding key), and (e.g. then) press the keys corresponding to the other letters (e.g. in this example, chain of characters “all”) of the word without speaking.

Different methods of correction of a non-desired word proposed by the predictive data entry systems of the invention based on the input information (e.g. key presses information, and speech information if any provided) provided by the user, have been described before.

As described in detail, during the entry of a word, a first input information including ambiguous input information (e.g. ambiguous key interactions corresponding to at least some of the characters of said word) and eventually unambiguous input information (e.g. key press and speech corresponding to at least one of the (e.g. other) characters of said word) may be provided by the user.

### EXAMPLE 1

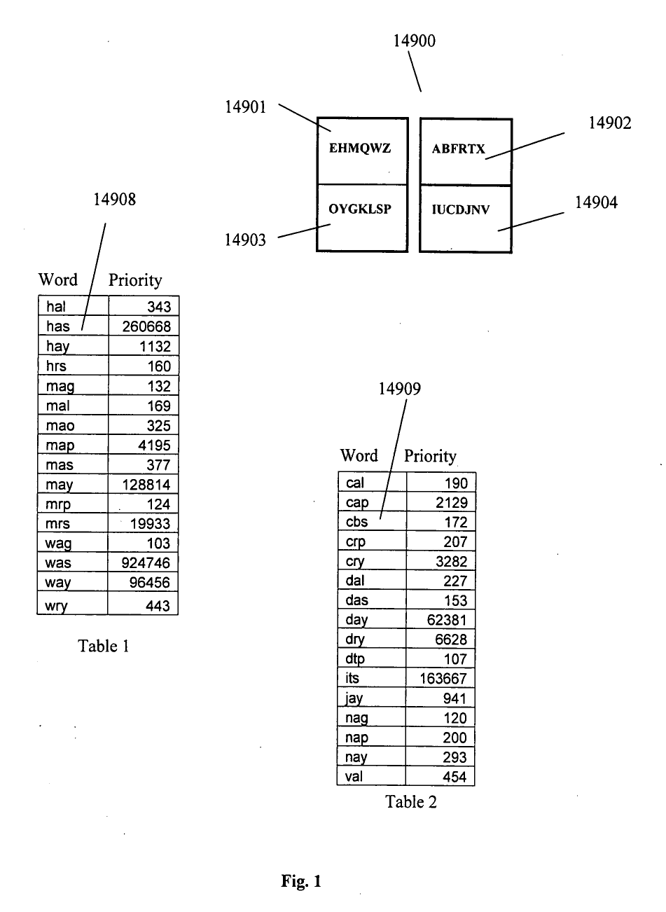

For Example, by considering the keypad 14900 of FIG. 1, pressing the keys 14901, 14902, 14903, without speaking may correspond to a group of words 14908 of the table 1 (e.g. reflecting a portion) of the database of the system. The system may propose the word “was” having the highest priority among said words. This word may not be the word that the user desires to enter.

A word proposed by the system based on said first input information may not be the one that the user desires to enter. In order to try to replace said word by the desired word, according to one method of correction, the user may proceed to a correction procedure by providing additional input information such as (e.g. if required as will be described later, pressing a predefined (e.g. “correction”) key and) speaking at least one-character/more-characters (e.g. preferably the beginning character(s)) of said word for entering said character(s) unambiguously. By considering said first input information and said additional input information, the system may propose a word among the group of words corresponding to the combined information wherein said word may preferably predefinely having the highest priority among said words.

### EXAMPLE 2

In the example 1, for example, providing a speech such as saying the letter “y” (during the entry of the word (related to the first input information) or during the correction procedure (related to the additional input information) corresponding to the pressing action that was provided on the key 14903, may correspond to any of the words of the group of words:
   “hay”
   “may”
   “way”
   “wry”
The system predefinely may propose the word “may” that has the highest priority among said words.

The system may also include a navigating system so that the user may inform the system to navigate within the words of the database that correspond to the input information (e.g. including the first input information, and the additional input information if any have been provided) corresponding to said word, provided by the user. According to a first method of navigation, if the word proposed by the system based on the input information (e.g. the first input information, and the additional input information if provided) provided by the user is a non-desired word, the user may provide a predefined command (e.g. key interaction, verbal command, etc.) such as for example providing a predefined pressing action on a predefined (e.g. “correction”) key (e.g. without speaking) and the system may propose another word among the group of words corresponding to the same said input information (e.g. the first information, and the additional information if provided) provided by the user wherein said another word preferably has the next highest priority after the non-desired word among the words of said group.

### EXAMPLE 3

according to this method of navigation, in the example 1, if the user provides a predefined pressing action on a predefined (e.g. “correction”) key, the system may provide the word “has” having the next highest priority after the word “was” among the words of said group (e.g. group of words that correspond to the first input information provided by the user.)

### EXAMPLE 4

according to this method of navigation, in the example 2, if the user provides a predefined pressing action on a predefined (e.g. “correction”) key, the system may provide the word “way” having the next highest priority after the word “was” among the words of the corresponding group (e.g. group of words that correspond to the first input information and the additional input information provided by the user.)

According to one embodiment of the invention, if the input information (e.g. provided by the user) corresponding to the first character of the desired word is ambiguous, then, according to a second method of navigation, if the word proposed by the system based on the input information (e.g. the first input information, and the additional input information if provided) provided by the user is a non-desired word, the user may provide a predefined command (e.g. key interaction, verbal command, etc.) such as for example providing a predefined pressing action on a predefined (e.g. “correction”) key (e.g. without speaking) and the system may propose another word among the group of words corresponding to the same input information (e.g. the first input information, and the additional input information if provided) provided by the user wherein said another word begins with the same beginning character of the non-desired word and wherein said another word preferably has the next highest priority after the non-desired word among the words of said group.

### EXAMPLE 5

according to this method of navigation, in the example 1, if the user provides a predefined pressing action on a predefined key, the system may provide the word “way” having the next highest priority after the word “was” among the group of words corresponding to the first input information (e.g. key presses corresponding to the characters of the word) provided by the user and wherein said words begin with the letter “w” (e.g. in this example, said group of words includes the words, “was”, “way”, “wry”, “wag”).

### EXAMPLE 6

according to this method of navigation, in the example 2, the word “may” is the only word that corresponds to the first input information (e.g. key presses corresponding to the characters of the word provided by the user) and the second input information (e.g. speaking the third letter “y”) provided by the user and wherein said word begins with the letter “m” (e.g. the first letter of the proposed word by the system). In this example pressing the navigating command maybe/is useless.

The navigating command may be repeated several times as needed (e.g. pressing the command/correction” key may be repeated several times) wherein each time the system may provide another word of the corresponding group of word wherein said another word preferably has the highest priority after the last proposed word.

Examples:
in the example 3, by providing an additional predefined pressing action on the predefined (e.g. “correction) key, the system may propose the word “may”. Still, one more additional predefined pressing action on the predefined (e.g. “correction”) key, may correspond to the word “may”. And so on.
in the example 4, by providing an additional predefined pressing action on the predefined (e.g. “correction”) key, the system may propose the word “hay”. Still, one more additional predefined pressing action on the predefined (e.g. “correction”) key, may correspond to the word “wry”. (e.g. in this example, the word “wry” is the last word in the corresponding group.)
in the example 5, by providing an additional predefined pressing action on the predefined (e.g. correction) key, the system may propose the word “wry”. Still by providing one more additional predefined pressing action on the predefined (e.g. “correction”) key, the system may propose the word “wag”. (e.g. in this example, the word “wag” is the last word in the corresponding group.)

According to one embodiment of the invention, said additional input information (e.g. speech) may be provided at the end of the first input information while the cursor is located at a predefined position such as immediately after the last character of the corresponding word (e.g. according to one method, to avoid a non-intended speech being erroneously perceived/considered by the system, the intended speech may be (e.g. started to be) provided within a predefined laps of time after the cursor is positioned at said position. If the user speaks after said laps of time, the speech may not be considered by the system. If the user intends to provide additional speech information, then he may move said cursor to another position (e.g. by pressing the space key) and brings it back again to immediately after the last character of the word (e.g. by pressing the “Bk Sp” key) and (starts) to speak within said laps of time.)

According to one embodiment of the invention, the navigating procedure (e.g. pressing actions on the “correction” key) preferably may be provided/considered-by-the-system when the cursor is located immediately after the last character of the corresponding word.

According to one embodiment of the invention, the additional (input) information (e.g. speech) may be provided by providing a predefined (e.g. type of) command (e.g. tapping, gliding voice command, etc.) such as providing a predefined type of pressing action on a predefined (e.g. “correction”) key and (e.g. substantially, simultaneously) providing said additional information. Providing the same/another predefined (e.g. type of) command such as providing the-same/another predefined type of pressing action on the same/another predefined (e.g. “correction”) key without providing a speech may correspond to said navigating procedure within the corresponding words. For example, pressing the keys 14904, 14902, 14903, of the keypad 14900 of FIG. 1, may correspond to the words 14909 of table 2 (e.g. reflecting another portion of the words database of the system). The system may propose the word “its” having the highest priority (e.g. based on frequency of use) among said words. If said word is a non-desired word, while said word is pointed to (e.g. while for example the cursor is-located immediately after the last character of said word, or by locating the cursor immediately after the last character of said word) the user may press a predefined (e.g. “correction”) key and preferably simultaneously say/pronounce the letter “d”. By considering the pressing action on the predefined (e.g. “correction”) key and detecting the user's speech, the system may understand that the user intends to provide additional information corresponding to said word. By analyzing said speech, the system may propose a word among the words of said table (e.g. corresponding to said key presses) that has the highest priority among the words that begin with the letter “d”. The system may propose the word “day”. If said word is not the desired word, then the user may (e.g. one time) press said predefined (e.g. “correction”) key without speaking. By considering the pressing action on the predefined (e.g. “correction”) key and not detecting a speech the system understands that the user may intend to navigate into the next word within the words of said table (e.g. corresponding to said key presses) that begin with the letter “d”, and wherein said next word has the next highest priority after the word “day” among said words. In this example, said word is the word “dry”. The system may propose said word to the user. The user may accept said word by providing another (e.g. different) action such as for example providing a space character or proceeding to the entry of the next word, etc.

As mentioned before, in any of the embodiments or methods relating to (e.g. predictive) data entry systems of the invention such as the above-mentioned embodiments, instead-of/in-addition-to providing speech information for the entry of unambiguous characters (e.g. of a word), other input methods such as handwriting input and recognition systems, a full/pc keyboard, etc., may be used for the entry of unambiguous characters. It must also be noted that a predefined interaction with a key may be a predefined action such as a single-pressing action on said key, or a double-pressing action on said key, or a gliding action on said key, or a longer-pressing action on said key, or press-and-holding on another key and pressing said key, etc. These matters have already been described in previous patent applications previously filed by this inventor.

As mentioned before, after entering a first input information (e.g. key presses, and speech if desired/required) corresponding to a word by using the predictive data entry systems of the invention, if the proposed word is not the one that the user desired to enter, the user may proceed to a correction procedure by providing an additional information such as speaking at least one of the (e.g. beginning) letters/characters of said desired word.

According to one embodiment of the invention, said additional information (e.g. speech) may be provided while said word is pointer-to/selected such as for example while the cursor is positioned at a predefined position relating to said none-desired word (e.g. such as immediately after the last character of the non-desired word, or on said non-desired word, or after the space character after said word, etc.) and providing a predefined interaction with a (e.g. predefined) key. For the entry of said additional (e.g. speech) information several methods of key interaction combined with providing said additional information may be considered.

According to a first method, the user may provide a single predefined key interaction such as a single single-pressing action on a predefined (e.g. correction) key and provide the speech corresponding to a (e.g. preferably, the beginning) character of the desired word. For inputting the additional information corresponding to each of the other (e.g. following) characters of the desired word, the user may repeat said predefined key interaction accordingly and speak the corresponding character. For example, by considering the keypad 14900 of FIG. 1 and by considering the database of words 14909 of the system, in order to enter the word “dry”, if the user enters a first input information by pressing the corresponding keys without speaking, the system may propose the word “its” which is not the word that the user intends to enter. Then (e.g. while pointing to said word, or when the cursor in located immediately after said word, or on said word, etc.) the user may, for example, provide two times a predefined pressing action (e.g. two single pressing actions) on a predefined (e.g. correction) key and (e.g. and preferably substantially simultaneously) provide a second information by speaking the letters “d” and “r”. The system may understand that the user intends to replace the word “its” by another word corresponding to said first input information (e.g. the same corresponding key presses originally provided by the user) and that the speech of its two beginning characters corresponds-to/is the speech provided by the user. The system proposes the word “dry” which is the only word of the database that corresponds to the combined first and second input information provided by the user.

According to a second method, the user may provide a press-and-holding action on the correction key and speak as much as characters he desires and then release said key.

According to a third method, the user may provide a single predefined key interaction and speak the desired word.

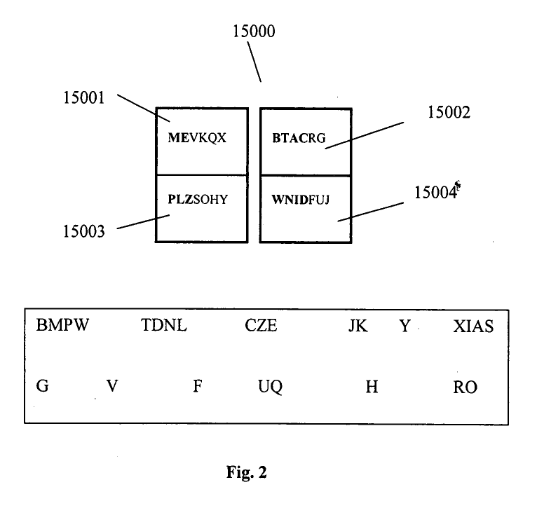

As mentioned before, the speech may also be detected and recognized by a lip reading system. Also as mentioned, for better accuracy, symbols such as letters of a language having ambiguously resembling speech relating to each other may separately from each other being assigned to different input signals such as to different keys. FIG. 2 shows an example of distribution of letters of the English language on four keys 15001-15004 of a (e.g. partial) keypad 15000 based on these principles. For example, letters “B”, “M”, “P”, “W” that at a predefined time during speaking each of them require the user's lips/mouth to be in closed position may be assigned to different keys. Also as example, letters “T”, “D”, “N”, “L”, that at a predefined time during speaking each of them require the user's tongue to be between the user's teeth in substantially closed position, may be assigned to different keys. Similarly, other letters having resembling lip reading characteristics have been separately from each other assigned to different keys. The word dictionary/database of the word predictive data entry systems based on key presses only usually contain about 25000 words. The predictive data entry systems of the invention permits the system to consider only few words corresponding to the user's provided input information. Therefore, a much larger dictionary of words may be considered wherein the system may still have a high level of performance.

According to one embodiment of the invention, the dictionary of words database of the system may contain the words of more than one, language, profession, environment, etc.

According to another method, multiple separate dictionary of words (e.g. of different languages, of different professions, of different environments, etc.) may be used with the predictive data entry systems of the invention wherein the user may switch within said databases (e.g. even during a same document) by using a switching means such as providing a predefined interaction with a predefined key, or a voice command, etc.

As mentioned before, during the entry of a word by using the combined (e.g. including the word predictive) data entry systems of the invention, a user may enter at least one characters such as a letter, by pressing a key corresponding to said letter/character and providing a speech corresponding to said letter/character (e.g. speaking said letter/character). According to one embodiment of the invention, said key press and said speech may preferably being provided simultaneously.

It may happen that (e.g. when user types fast) the user's speech corresponding to a key press of consecutive key presses, is provided during more than one of said (e.g. quick) consecutive pressing actions (e.g. said speech may cover more than one of said consecutive key presses). This may cause ambiguity for the system that erroneously may consider that user's speech corresponds to the consecutive key presses covered by said speech.

According to one embodiment of the invention, in order to help the system to better recognize the user's intention:
if the user provides a speech during quick consecutive key presses (e.g. the laps of time of interval between each of the two of said key pressing actions being less than a predefined laps of time), wherein said speech does not cover some of said quick consecutive key presses provided after (the beginning of) said speech, then predefinely, the system may consider that said user's speech may correspond to one of said consecutive key presses only, wherein preferably predefinely said key press being the key press during which said user's speech began to be provided.
If the user's intends to provide the speech corresponding to two or more quick consecutive key presses, the user may:
   provide at least a predefined laps of time of interval/pause at the end of the entry of the quick consecutive key presses corresponding to said speech, or;
   press and speak in a moderate speed by providing at least a predefined laps of time of delay/pause between each of the consecutive key presses (e.g. and each of their corresponding speech).

The above-mentioned rule may also be applied to the entry of portion-of-a-word(s) and/or the entry of characters and portion-of-a-word(s) mixedly. For example:
if the user provides the speech corresponding to a chain of characters such as a portion-of-a-word during quick consecutive key presses wherein said speech does not cover some of said quick consecutive key presses provided after (the beginning of) said speech, then predefinely, the system may consider that said user's speech may correspond to one of said consecutive key presses only (e.g. the system may suggest that said speech is predefinely assigned-to/represented-by said key press), wherein preferably predefinely said key press being the key press during which said user's speech began to be provided.
If the user intends to provided the speech corresponding to two or more quick consecutive key presses (e.g. said speech may be such as speaking at least two characters, or at least two portion-of-a-words, or at least one character and one portion-of-a-word, etc) the user may:
   provide at least a predefined laps of time of interval/pause at the end of the entry of the quick consecutive key presses corresponding to said speech, or;
   press and speak in a moderate speed by providing at least a predefined laps of time of delay/pause between each of the consecutive key presses (e.g. and each of their corresponding speech).

During providing several quick consecutive key presses, the user may provide more than one speech (corresponding to more than one of said key presses). Obviously, the above-mentioned principles automatically respond/apply to said situation.

(e.g. If some of said consecutive key presses provided during and between each two successive speeches are not covered by those (e.g. any of said two) speeches, then based on the principles as described, the system may consider that:
the first speech of said two user's speeches may correspond to one of said consecutive key presses only, wherein preferably predefinely said key press being the key press during which said first user's speech began to be provided, and;
the second speech of said two user's speeches may correspond to one of said consecutive key presses only, wherein preferably predefinely said key press being the key press during which said second user's speech began to be provided.)

It is understood that any of the user's speeches may be speaking a corresponding character such as a letter, or speaking a corresponding portion of a word, etc.

As an example of the principles described above, by considering the (partial) keypad 15000 of FIG. 2, in order to enter the phrase “we are meeting”, if the user presses the keys only, corresponding to the characters of said phrase, the system may erroneously output the phrase “he are meeting” (e.g. the word “he” has predefinely higher priority than the word “we”). Obviously, after a short amount of practice, the user may know in advance that in order to enter the word “we”, according to one method, while pressing the key corresponding to the letter “w”, he may speak said letter, and the press the key corresponding to the next letter “e” without speaking. Obviously, after some amount of practice, the use will also be able to type quickly. During the entry of said phrase, the user may quickly type the keys corresponding to the characters of said phrase. While pressing the key corresponding to the letter “w”, the user may speak said letter. Because the user types fast, in addition to covering the corresponding key press 15001, his speech corresponding to the letter “w” may also cover one or more following key presses of said consecutive key presses. By using the above-mentioned embodiment, by recognizing that said speech has been provided during quick consecutive key presses, the system may understand/decide that said speech belongs to the key press 15001 during which the speech began to be provided. This permits the user to type fast.

The above-mentioned embodiment/methods may significantly improve the speed of the combined (e.g. including the word predictive) data entry and correction systems of the invention. This is because during the entry of a text, most of the words (e.g. existing in the database of the of the system) the text are generally outputted by the system based on the corresponding key presses only, provided by the user. In addition, by using/considering the correction procedures of the system, generally, the user may rarely need to speak more than one character of a word (e.g. existing in the database of the system) for entering said word. Additionally, when the user speaks a sequence (e.g. two or more) of consecutive/successive characters, mostly, he naturally speaks them slowly, and usually naturally provided a pause at the end of said consecutive/successive speeches. By combining the methods just described within the combined (e.g. including the word predictive) data entry and correction systems of the invention, an extremely, quick, easy, and most importantly, natural mobile data entry and correction system may be provided. This data entry system is even easier than using a standard (e.g. QWERTy) keyboard, therefore, after using it during a short amount of time, it may become the preferred data entry system for the fixed devices such as desktops, too.

It must again be noted that when correcting/changing a none-desired word (e.g. corresponding to initial input information that may include key presses, and speech if was provided) proposed by the system, the user may provide additional input information such as the speech corresponding to one or more than one character/letter of said word. For example, for entering the speech of more than one character of the desired word, the user may press a predefined interaction with a predefined (e.g. “correction”) key multiple (e.g. “n”) times corresponding to the number of multiple (e.g. “n”) (e.g. preferably, consecutive beginning) characters/letters of the desired word and provide the speech corresponding to said characters/letters (e.g. by speaking said characters/letters).

If the system uses the same, correction key and key interaction, for a first correction procedure consisting of providing multiple (e.g. “correction”) key-press-and-speech corresponding to the multiple (e.g. preferably, at least the beginning) letters/characters of the desired word, and a second correction procedure consisting of providing multiple key-presses-and-speech wherein each of said multiple key-press-and-speech intends to inform the system to propose the word (e.g. having the highest priority among the words) of the group of words corresponding to the initial/first (e.g. key presses) information (e.g. corresponding to the characters of the desired word) and at least the additional speech information provided during said (“correction”) key press, then in order to help the system to distinguish between those two correction procedures, the following rule may be applied:
Providing said predefined key interactions and speech, quickly (e.g. by providing a laps of time of delay/pause between the consecutive correction key interactions wherein said laps of time of delay/pause being inferior to a predefined laps of time) may correspond to the first correction procedure, (e.g. if desired, the user may even provide the speech corresponding to all of the characters/letters of the word while providing the corresponding interactions with said (“correction”) key as much as needed such as pressing said key a number of yimes corresponding to the number of the characters of the desired word. This is practical for entering out-of-the-dictionary words) and;
Providing said predefined key interactions and speech in a moderate speed (e.g. by providing at least said predefined laps of time of delay between the consecutive correction key interactions) may correspond to the second correction procedure
   Each additional pressing action on the (“correction”) key without speaking (e.g. in this case interpreted as “next word” key) may inform the system to navigate within the words corresponding to the initial key presses corresponding to the characters of the desired word, and the at least the additional speech information provided by the user during the correction procedure(s) corresponding to said word, so that the system may propose the word having the next highest priority among said words.

According to one embodiment of the invention, for entering the speech (e.g. in order to help the system to recognize at least some of the precise character(s) of the desired word) during the correction procedure for correcting/replacing a proposed word, the user may speak said character/portion-of-a-word/word without providing any key interaction (e.g. the system may not have a predefined (e.g. “correction”) key or the user may not use a predefined (e.g. “correction” key)). For this purpose the user may predefinely select/point to the undesired proposed word and then provide said speech. The user may use a predefined (“correction”) key for navigating within the words corresponding to initial the input information (e.g. key presses, and eventually speech if was provided) corresponding to the characters of the word (initially provided by the user), and the speech information provided during the correction procedure.

It must be noted that according to one embodiment of the invention, during the correction procedures of the invention, a first predefined key (e.g. or a first predefined key interaction with a predefined key) may be assigned the correction procedure for the entry of the user's additional speech information corresponding to the character(s) of the desired word, and a second predefined key (e.g. or a second predefined key interaction with a predefined key) may be assigned to the correction procedure for navigating (e.g. used as “next word key”) within the words corresponding to the initial input information provided by the user, and the additional input (e.g. speech) information provided during the correction procedure if said additional information is provided.

According to another embodiment, a predefined means such as a predefined key or speech command may be used to switch between a first and second correction procedures.

According to another embodiment, a predefined means such as a predefined key or speech command may be used to switch between a first and second correction procedures when using the same correction key (e.g. or the same predefined interaction with the correction key) for each of said correction procedures. For example, a first correction procedure may use a predefined key (or a predefined key interaction with a predefined key) during the entry of the additional (speech) input information and a second correction procedure may use the same predefined key (or a predefined key interaction with a predefined key) for navigating procedure through the words corresponding to the initial input information and the additional input (e.g. speech) information (provided during the correction procedure) provided by the user.

It must be noted that although the term “proposed word” have been used in many paragraphs of the patent applications filed by this inventor, said term intends to describe a word being proposed or to be proposed by the predictive data entry system of the invention. For example, sometimes during the entry of the ambiguous and unambiguous input information corresponding to a word, the user may know in advance which word the system will select. The user may not desire said word and may proceed to correction procedure immediately after the entry of the input information (e.g. before said word is proposed to the user). Also for example, according to another embodiment, the system may not provide any (e.g. proposed) word until the user provides a predefined command, etc.

It must also be noted that all of the key interactions during the correction procedures of the invention may be replaced-by or being combined-with other data entry methods such as voice command. For example, to navigate through the words corresponding to initial input information, and the additional (speech) information if has been provided, (e.g. after pointing to said word) the user may use a predefined voice command such as for example saying “next”. Also for example, to enter an additional (e.g. speech) input information corresponding to one or more characters of said word, (e.g. after pointing to said word) the user may speak said character(s), portion-of-a-word(s), etc.

It must again be noted that the initial (e.g. first) input information provided by the user contains the key presses corresponding of at least some of the characters (e.g. generally all of the characters) of said word and eventually the speech (e.g. if provided) corresponding to some of the characters of said word. According to one embodiment of the invention, during the correction procedure of the invention, predefinely, some of the speech including in the initial information corresponding to some of the characters (e.g. mostly, the speech provided for the middle character(s)) of the word may not be considered by the system.

According to one embodiment of the invention, during the correction procedure, when the user navigates through the words corresponding to initial input information, and (if provided) the additional (e.g. speech) information provided during the correction procedure (if has been provided), after the system proposes the last word (e.g. the word having the lowest priority among the words corresponding the initial and additional (e.g. if provided) input information, an additional predefined command (e.g. an additional, predefined interaction such as a predefined interaction with a predefined (e.g. “correction”/“next”) key or the voice command), may cause the system to (e.g. cyclely/looply) propose the word having the highest priority among the group of words corresponding to said information. Each additional same predefined interaction may inform the system to propose the word having the next highest priority among the remaining words of said group of word.

It must be noted that in the embodiment above, according to one method, after the system proposes the last word of the group (e.g. the word having the lowest priority among the words corresponding the initial and additional (e.g. if provided) input information, by providing an additional predefined command (e.g. an additional, predefined interaction such as a predefined interaction with a predefined (e.g. “correction”/“next”) key or the voice command), the user may provide the speech corresponding to all of the characters of the desired word (e.g. speaking them one by one).

According to one embodiment of the invention, during the correction procedure, when the user navigates (by pressing the “next/Correction” key without speaking) through the words corresponding to initial input information, and (if provided) the additional (e.g. speech) information provided during the correction procedure (if has been provided), after the system proposes the last word (e.g. the word having the lowest priority among the words corresponding the initial and additional (e.g. if provided) input information, an additional predefined command (e.g. an additional, predefined interaction such as a predefined interaction with a predefined (e.g. “correction”/“next”) key or the voice command), may cause the system to propose the word having the highest priority among the group of words corresponding to the initial key presses information only. Each additional same interaction may inform the system to propose the word having the next highest priority among the remaining words of said group of word.

As mentioned in different patent applications filed by this inventor, the input information provided by the user through an electronic device may (remotely) be transmitted to a central computing device such as a server computer, wherein at least part of the system such as the data processing/recognition modules of the system corresponding to the input information provided by the user are installed. After processing the user's input, the result (e.g. the output) may be transmitted to a destination such as the user's electronic device (e.g. so that the user verify the accuracy) or to another destination. For example, if the user's electronic device is a cell phone having limited processing power and/or memory size, the user may enter the key presses and speech (corresponding to a desired text) according to the principles of the data entry system of the invention. He then, may transmit said information to the remote computer through cellular network or another network. After receiving the result/output text and verifying its accuracy, the user may send the text to his desired destination, or he may input a confirmation signal to the remote computer, so that said computer sends the text result to user's desired destination, etc.

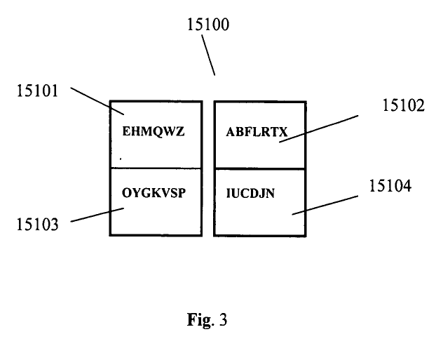

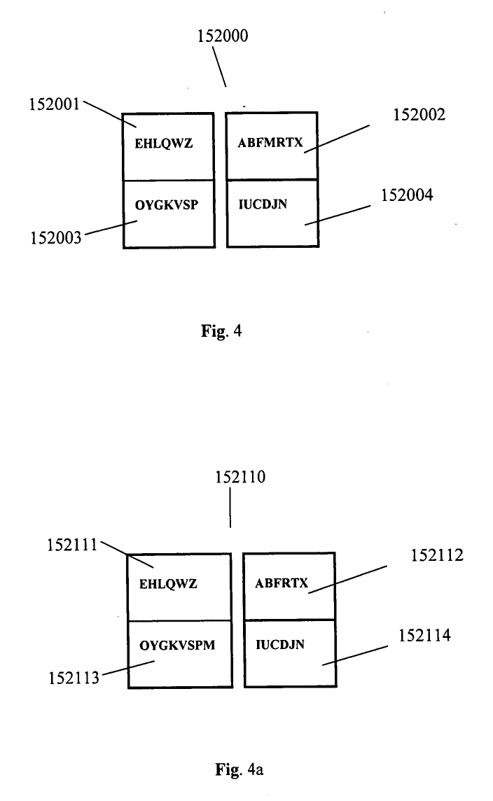

Different methods of distribution/assignment of the letters of the English language to four keys of a keypad have been shown and described in detail before. FIG. 3 shows another example of distribution/assignment of the letters to four keys based on those principles such as at last some of at lest the following principles:
letters having ambiguously resembling speech are assigned to different keys
letters being assigned such that generally most of the words of a text do not require speech input information (corresponding to a letter/Portion of a word)
letters being assigned to the keys and keys being located relating to each other such that they may be used generally (as much as possible) evenly
   In this example, the distribution/assignment of those letters resembles to that of the keypad of the FIG. 1 with slight modification. The letter “v” is moved to the key 15103 (e.g. when using a low-end/far microphone or when whispering, etc., the letter “V” and the letter “D” may be misrecognized relating to each other) and the letter “L” is moved to the key 15102 (e.g. when using a low-end/far microphone or when whispering, etc., the letter “L” and the letter “O” may be misrecognized relating to each other).

As mentioned previously, while providing quick pressing actions if the user also provides the speech (e.g. an utterance) corresponding (e.g. to be considered combined with) to at least one of said pressing actions, said speech may cover some of the quick pressing actions after those who were intended to be covered. Different methods to resolve this issue have been/may-be proposed. For example, according to one method, the system may consider/combine one or more of at least:
one (e.g. beginning)
N−1 (e.g. beginning)
N (all)
other number of
   pressing actions covered by said speech, with said speech, and decide which of them provides the best result. Also as an example, according to another method to resolving this problem have was described in the precious provisional patent application filed by this inventor. Obviously, the system may consider/combine one or more of said methods simultaneously to produce the best result.

As described in detail in different patent applications filed by this inventor, a data entry system of the invention discloses a system for entering at least arbitrary characters and/or one or more a-portion-of-word (e.g. corresponding to a syllable) (i.e. hereafter, the a-portion-of-a-word may be written as “Portion”), using a (e.g. keypad having) reduced number of (e.g. hard, soft, virtually duplicated, etc.) keys. Also as mentioned, the data entry system of the invention may use a number of elementary symbols of at least one language for either the input or editing of a text or the manipulation of a computer. Said number of symbols may include substantially all of the elementary symbols such as at least one of the groups of:
the text symbols such as letters, portion-of-a-word (e.g. corresponding to a syllable of a word)
digits,
punctuation marks,
commands, functions, etc.

The symbols may be distributively assigned to the keys such that at least two of the text symbols being assigned to at least one key. As described before, in order to enter precisely one of the (text) symbols (e.g. a letter, a Portion) assigned to a key, the user may provide a predefined interaction with the key such as a pressing action on the key and provide a speech information corresponding to the symbol (e.g. such as speaking (e.g. the appellation of) the letter, speaking the (syllable of the) portion) for selecting the symbol (e.g. letter) among the symbols (e.g. letters) that are assigned to (a predefined interaction with) the key, and wherein the speech information may be detected and analyzed based on at least one of, the user's voice and/or the user's lips movements. Said precise text symbol may be part of a word being entered through the combined (e.g. including the predictive) data entry system of the invention wherein the user may not provide the speech corresponding to some of the key presses corresponding to some of the letters/portions of said word. The data entry systems and their enhancements have been described in this and different other patent applications filed by this inventor. For example, according to one method, in order to enter a word or a Portion, the user may press at least one of the (e.g. beginning) corresponding keys of said portion and speak said portion. Obviously, as described, the combined (e.g. including the predictive) data entry and correction systems of the invention may be used for the entry of the text in different letter-based (e.g. alphabetical-based) languages such (e.g. English, French, Korean, etc.).

Also, obviously, the combined (e.g. including the predictive) data entry and correction systems of the invention may also be used for the entry of an ideographic text such as Chinese, Japanese, etc. The only difference may be that each word/entry (e.g. chain of text symbols (e.g. letters in Roman-based language) that in this case may be the phonetic symbols corresponding to an ideological character/word such as described later in this patent application) of the database of ideological may represents an ideological character/word therefore the dictionary of the characters/words of the ideological language may include the corresponding (e.g. written) ideological characters/words wherein after entering the input information (e.g. key presses, and speech if provided) instead of printing the predicted/selected character/word in phonetic symbols, the system may print the corresponding ideological character/word.

Every written character in an ideographic language such as Chinese language can be represented by a phonetic representation of the character. There are several phonetic systems for entering Chinese characters such as pinyin and Bopomofo.

Pinyin is a Romanized phonetic system of the Chinese language, used to represent Chinese sounds with European letters. Of all the 26 letters of the English alphabet, 25 are used in Pinyin. The sound “V” is not a phoneme used in the Chinese language. Although the letters are the same, the sounds they represent differ in some cases. For this reason, there is really no easy way to tell from pinyin exactly how the Chinese words sound, but it is extremely easy for an English speaker to guess.

The Bopomofo is another standard used to represent Chinese sounds, except instead of English roman letters, it uses Chinese-derived letters for the alphabet. Since the Bopomofo has 37 normal characters, it can provide a more complete spelling for Chinese words than the 26 letters of English can.

In Chinese, syllables are composed of consonants, vowels, and tones. According to traditional notation, each Chinese syllable is composed of an “inital” and a “final”.

English words are made up of vowels and consonants. In Chinese, every syllable is made up of initials and finals.
An initial is basically equivalent to an English consonant. Initials are the first 21 symbols of the bopomofo
A final is basically equivalent to an English vowel. A final can be combined with other finals to form a compound final. While the bopomofo contains 16 of the pinyin finals, pinyin also includes additional compound finals. There are also a few pronunciation rules about how initials and finals can be put together.

Each character of the Chinese language can be represented by the combination of one, two, or more Phonetic Symbols.

To enter an ideographic character such as a Chinese character that is represented by a number of phonetic symbols, the corresponding keys may (respectively) be pressed. Because more than one phonetic symbol may be assigned to a key the keys pressed may correspond to more than one corresponding character. This may cause ambiguity. The ambiguity may be solved by using the principles of the data entry systems of the invention.

For entering a text in an ideographic language through the combined data entry systems of the invention, the letters (e.g. the phonetic symbols) may be distributedly assigned to the keys of a keypad based on the principles of the symbol assignments of the data entry systems of the invention described in different (e.g. this and others) patent applications filed by this inventor. For example, the phonetic symbols having ambiguously resembling speech may separately from each other being assigned to, different keys or to different interactions with the keys. Also for example, said phonetic symbols may preferably be separated from each other in different group based on the principles of the data entry systems of the invention such that to use as few keys as possible such as, preferably four keys (e.g. or to at least some of the keys of a telephone-type keypad).

The predictive ideological data entry system of the invention may have word wherein, in addition to corresponding key presses (e.g. value) information, each of the ideological words of the database of the ideographic language may have its corresponding phonetic symbol information. The system may also include a database of (e.g. single) characters and their corresponding key presses to enter/select (e.g. single) characters (e.g. of a word) based on the user's input information (e.g. key presses, and corresponding speech(s) if needed). The system may also include a database of (e.g. single) syllable-based stems and their corresponding key presses to enter/select (e.g. single) syllable-based stems (e.g. of a word) based on the user's input information (e.g. key presses, and corresponding speech(s) if needed).

Obviously, all of the other data entry, edition, correction, and enhancements described in this and other patent application filed by this inventor may apply to this level of data entry (e.g. in the appropriate paragraphs/embodiments of said patent applications the term “letter” and/or “character” can be considered-as/relate-to the phonetic symbol). For example, in order to enter a phonetic symbol, the user may press the corresponding key and provide the corresponding predefined speech. Also, as example, when using the predictive data entry of the invention, if the word proposed is not the desired word, the user may proceed to correction procedure by (e.g. pressing a correction key) and speaking the beginning phonetic symbol of the word.

For better accuracy, the system may also use the corresponding language rules such as combination rules of initials and finals as mentioned above.

According to one method of data entry, for example, in order to enter an ideographic character, while the user presses the keys corresponding to phonetic symbols, for better accuracy, the user may provide the speech-of/corresponding-to at least one of said phonetic symbols. If needed, at the end of the entry of the input information (e.g. key press(es), and speech if provided) corresponding to said ideographic character, the user may provide an ending signal such as pressing a predefined key. The system compares the input information provided by the user with the (stored) information of the ideographic characters of the dictionary to propose a corresponding character. If the proposed character is not the one that the user intended to enter, the user may proceed to a correction procedure so that the system may propose another character. The proposition of the ideographic characters to the user and correction/modification procedures for navigation within the corresponding characters of the corresponding dictionary may be similar to that explained (e.g. for word entry) in this and the previous patent applications filed by this inventor. Through this method the user may enter (an) ideographic word(s), character (e.g. precisely) by character (e.g. precisely).

According to one method of data entry, for example, in order to enter an ideographic word, while the user presses the keys corresponding to phonetic symbols of the word, for better accuracy, the user may provide the speech-of/corresponding-to at least one of said phonetic symbols. If needed, at the end of the entry of the input information (e.g. key press(es), and speech if provided) corresponding to said ideographic word, the user may provide an ending signal such as pressing a predefined key. The system compares the input information provided by the user with the (stored) information of the ideographic words of the dictionary to propose a corresponding word. If the proposed word is not the one that the user intended to enter, the user may proceed to a correction procedure so that the system may propose another character. The proposition of the ideographic words to the user and correction/modification procedures for navigation within the corresponding words of the corresponding dictionary may be similar to that explained (e.g. for word entry) in this and the previous patent applications filed by this inventor.

According to another method of data entry, for example, in order to enter an ideographic character/word, while the user presses the keys corresponding to phonetic symbols (e.g. of a corresponding syllable), for better accuracy, the user may provide the speech-of/said syllable. If needed, at the end of the entry of the input information (e.g. key press(es), and speech if provided) corresponding to said syllable, the user may provide an ending signal such as pressing a predefined key. The system compares the input information provided by the user with the information of the stored information of the syllables dictionary to propose/select a corresponding syllable.

Different methods of distribution/assignment of the letters of the English language to four keys of a keypad have been shown and described in detail before. FIG. 4 shows another example of distribution/assignment of the letters to four keys based on those principles such as at last some of at lest the following principles:
letters having ambiguously resembling speech are assigned to different keys
letters being assigned to the keys such that generally most/many of the words of a text are entered based on the key interactions (e.g. key presses) only (e.g. mostly do not require the speech input information corresponding to a letter/Portion of a word when pressing the corresponding key)
letters being assigned to the keys and keys being located relating to each other such that (e.g. during the entry of a text) they may mostly be used (e.g. pressed) evenly.

In the (e.g. partial) keypad 152000 of FIG. 4, the distribution/assignment of those letters resembles to that of the (e.g. partial) keypad of FIG. 3 with slight modifications. The letter “M” is moved to the key 152002 and the letter “L” is moved to the key 152001 (e.g. they are swapped). In this arrangement, the keypad greatly responds/corresponds to the principles described above.

In the (e.g. partial) keypad 152110 of FIG. 4a, the distribution/assignment of those letters resembles to that of the keypad (e.g. partial) of FIG. 4 with a slight modification. The letter “M” is moved to the key 152113. This keypad also responds to the principles described above.

It is understood that other arrangement assignment of letters in any language to any few number of keys, based on any of (e.g. preferably all) of the principles described above may be considered by those skilled in the art. For example, other slight modifications deriving from the letter arrangements on four keys shown here and in the previous patent applications filed by this inventor may be considered.

Different methods of entering precise characters, without providing speech, have been described before. According to one embodiment of the invention, the keypad of the invention may be designed such that when the user presses (e.g. and preferably holds) a first key corresponding/representing a desired character (e.g. letter), he may press a second corresponding (e.g. predefined) key to enter said character precisely. As an example, in addition to a (e.g. short) single press on a (first) key of a (e.g. ambiguous) keypad of the invention (e.g. for the entry of an ambiguous letter), another predefined interaction with said key such as a long press, press-and-hold, etc, may inform the system that the user desires to enter a precise character (e.g. letter) without speaking. The user may (preferably, simultaneously) press a second corresponding key to enter the desired character. The another pressing action on the (e.g. first) key corresponding to a (e.g. ambiguous) character/letter may (predefinely) map each of at least some of the (ambiguous) characters/letters of said key to a different key of the keypad. Then the user may (preferably simultaneously) press the corresponding different (second) key corresponding to said character/letter.

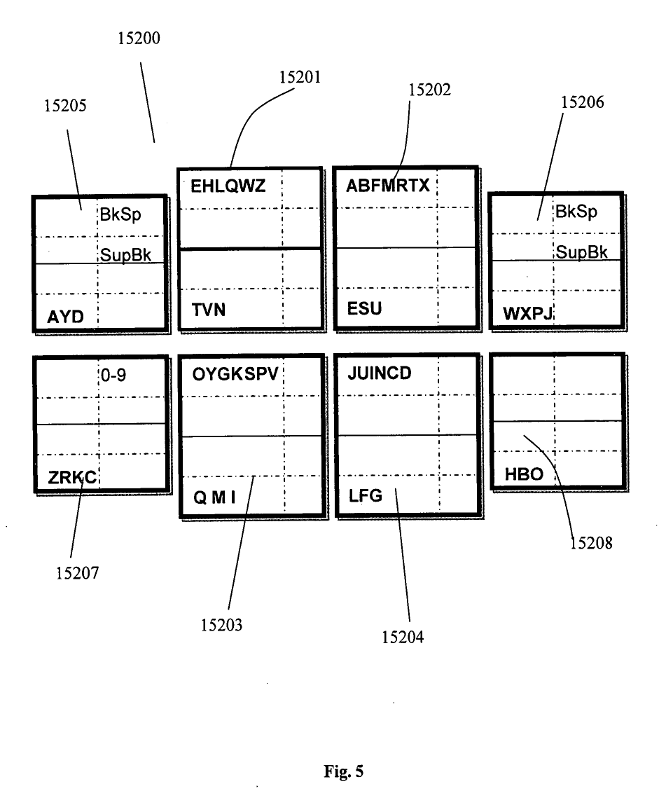

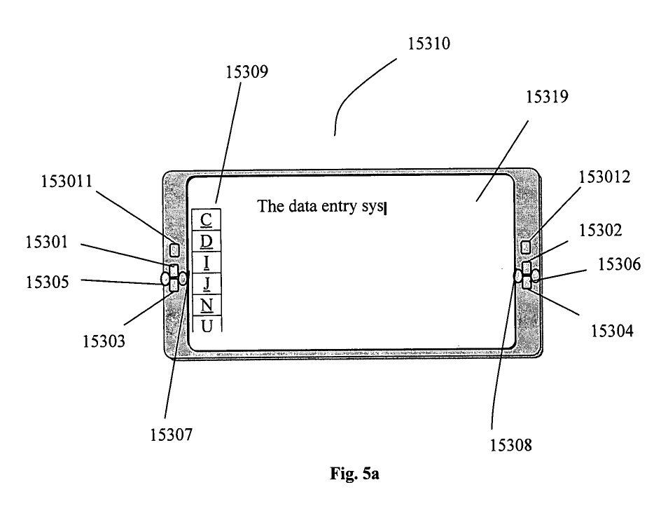

FIG. 5 shows as an example a keypad of the invention wherein letters are assigned to four of its keys based on the principles of the data entry systems of the invention as described before. Letters assigned to each of the keys 152201-15204 are shown on the upper zone of each of said keys. As an example, a single-pressing action on any of said keys may provide an ambiguous character of a word. Another (predefined) type of interaction with each of said keys 15201-15204 may map the letters on the key to a different key among the keys 15201-15208. as an example, the mapped letter of each of the key a 15201-15204 are shown on the lower zone of the keys 15201-15208. For example, in order to enter the letter “L” the user may press the key 15201 and (preferably simultaneously) press the key 15204. Also as an example, in order to enter the letter “B” the user may press the key 15202 and (preferably simultaneously) press the key 15208. The mapped characters/letters corresponding to each group of (ambiguous) characters/letters of a key may be printed on the corresponding mapped keys of the keypad, and/or they may be dynamically printed on the corresponding mapped keys of a (virtual) keypad each time the corresponding first key is pressed. For easier interface/interaction, each group of the ambiguous characters of a key and its corresponding mapped characters on the corresponding keys may be printed in a color, font, etc., that is different from another group of the ambiguous characters of another key and its corresponding mapped characters.

As mentioned, FIG. 5 shows as an example, four groups of ambiguous letters (e.g. of the keys 15201-15204) and the corresponding mapped letters on the eight keys 15201-15208 (shown on the bottom of each key) of a keypad 15200.

Same principles may be applied for the entry of other (ambiguous) characters of a key. For example, for the entry of the digits (e.g. 0-9) the user may press the corresponding (first) key (15207 in this example) and (preferably simultaneously) press the corresponding second key.

If the number of keys of the keypad is not sufficient for mapping each of the ambiguous characters of the key to a different key of the keypad, then more than one character may be mapped to a key such that at least each of some of the mapped characters to a key may be assigned to a different interaction with said key.

Obviously, the procedure of the entry of the precise letters as shown above may be used with the embodiments of the entry and/or correction procedures of the predictive data entry systems of the invention as described in this and previous parent applications field by this invention to reduce and/or eliminate the need of the speech.

It must be noted that the keypad of the example is shown only as one example, to demonstrate the principles of the entry of the precise letter just described. Other examples may be considered by those skilled in be art.

As mentioned before, when using the word-predictive system of the invention to enter a word (e.g. at the end of the entry of the initial input information (e.g. key press(es), and speech if any provided) corresponding to a word), if the word proposed by the system is not the desired word, the user may proceed to the correction procedure by providing additional input information corresponding to the desired word.

### According to one embodiment of the correction procedure of the invention,

a) if the user provides a predefined (correction) command such as providing a predefined pressing action on a correction key without providing speech, the system, preferably, provides the word having the next highest priority (e.g. based on the frequency of use) among the group of words of the dictionary database of the system that correspond to the initial input information provided by the user. Each additional command (e.g. pressing the correction key) without providing speech may preferably and respectively, provide another word of the group, that has the next highest priority.
b) if the user provides a predefined command such as providing a predefined pressing action on a correction key, and provides the speech corresponding to at least one of the (e.g. preferably, the beginning) characters of the word, the system, preferably, provides the word having the highest priority (e.g. based on the frequency of use) among the words of the dictionary database of the system that correspond to the combined (e.g. initial and additional (e.g. correction)) input information provided by the user. Each additional command (e.g. pressing the correction key) without providing speech may, preferably and respectively, provide the word having the next highest priority among the words of the database that correspond to said initial and said additional input information provided by the user.
With continuous description of the embodiment, if the desired word and the word proposed by the system based on the initial input information have the same beginning character, then in order to navigate within the words of the dictionary corresponding to said initial information and having said (e.g. beginning) character, the user may provide additional input information by providing (e.g. if predefinely required, a pressing action on the correction key, and providing) the speech corresponding to (e.g. speaking) said character. The system may propose a word (e.g. preferably, the word having the next highest priority) among the words of the dictionary database of the system that corresponds to the combined (e.g. initial and additional) input information provided by the user. Each additional command (e.g. pressing the correction key) without providing speech may preferably provide the word having the next highest priority among the words of the database that correspond to said initial and said additional input information provided by the user.
It must be noted that according to one method, the additional input information (e.g. speech) provided during the correction procedure may replace the corresponding previous (e.g. initial and/or) speech information provided by the user.

Different methods of entering precise characters, without providing speech, have been described before. According to another embodiment of the invention, the system may be designed such that when the user presses (e.g. and preferably holds) a first ambiguous key corresponding/representing a desired (ambiguous) character (e.g. letter), the system may provide a number of (soft) keys/(zones on the screen of the device) such that to each of said (soft) keys one of the (“ambiguous”) characters of the ambiguous key is assigned. The user then may press the corresponding (soft) key to enter the precise (unambiguous) character.

FIG. 5a shows as an example, an electronic device 15310 having the data entry system of the invention that uses few keys 15301-15308 that in this example respectively duplicate the keys 15201-15208 of the keypad 15200 of FIG. 5. in this example, in order to enter unambiguously the letter “d” the user may press (e.g. and hold) the key 15304. The system may show at least six on-screen keys 15309 each representing/corresponding to one of the letters represented by/assigned to the key 15304 (e.g. there may be more on-screen keys to represent other characters represented by the key 15304). The user then may press the on-screen key corresponding to the letter “d”.

Obviously, the precise letter(s) entered through this embodiment may be used during the entry of the words through the predictive data entry system of the invention.

According to one method of the embodiment described above, each time the user presses an ambiguous (e.g. in this example a hard) key the system provides the corresponding unambiguous (e.g. soft/on-screen) keys. in this case:
if the user provides a pressing action on a corresponding unambiguous (soft) key
   the system provides the corresponding unambiguous character
if not (e.g. if the user provides a pressing action on a key other than said on-screen keys relating to said ambiguous key that was pressed by the user)
   the system considers said ambiguous key pressing action provided by the user

The user may provide one or more consecutive pressing actions on the unambiguous (e.g. mapped) keys corresponding to one ambiguous key pressing action (e.g. to provide consecutive unambiguous characters).

When the ambiguous keys are split on opposite sides of a device, then preferably each pressing action on an ambiguous key may preferably provide the corresponding unambiguous (on-screen) keys on the opposite side of the device as shown in FIG. 5a.

The device using the data entry system of the invention may be a communication device such that to use dialing procedures. In this case as mentioned in previous patent application field by this inventor, the keypad may have at least ten keys that may include the data entry keys of the invention wherein (e.g. when the device is not in data/text entry mode) each of the ten keys may represent one of the digits 0 to 9, so that a pressing action on each of said keys (without speaking) provides the corresponding digit to permit dialing (telephone) numbers. As shown in the example of FIG. 5a, in addition to the keys 15301-15308, the keypad of the device 15310 to include at least two additional keys 153011, 153012 to duplicate the number keys of a telephone keypad so that (e.g. when the device is not in the text mode) said ten keys may permit to dial numbers.

It is understood that in order to switch between data/text entry mode and dialing mode, a switching means (e.g. button, voice command, etc.) may be used.

As mentioned in different patent applications field by this inventor, the system may use one of more of any speech recognition systems to recognize the user's speech. For example, the recognition system may be based on user's, voice, lip/face movements during speech, there/lip relationship during speech, bone/skin vibrations during speech, etc. Obviously, for such recognitions corresponding instruments (e.g. microphone, camera, sensor, etc.) may is used.

Different methods of presentation of a predicted word during the correction procedures of the invention have been described in different patent applications field by this inventor. According to another method, during/after-proceeding-to the correction procedure, the beginning character and/or (each of) the precisely entered character(s)/letter(s) of the predicted word may be presented in a predefined manner such as being presented by one of more predefined characters (e.g. “_”, “*”, “-”, etc.). After confirming the word, by a predefined confirmation manner such as for example, providing a providing a space character, the system may enter the word (e.g. having the complete characters).

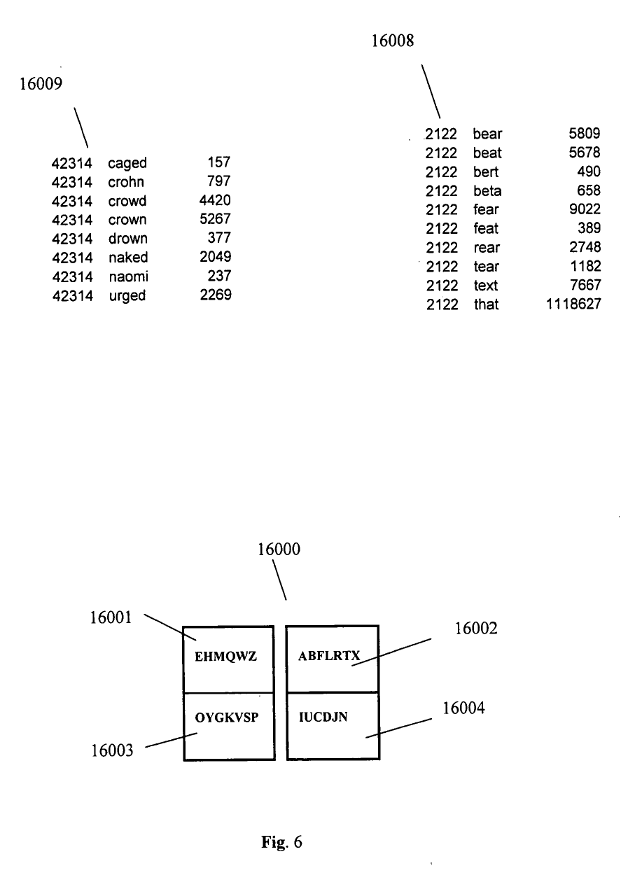

For example, as shown in FIG. 6, by considering the keypad 16000 and the portion 16009 of the words of the dictionary of the system, in order to enter the word “crowd”, after the user presses the corresponding keys, the system may propose the word “crown”. The user may press the correction key without providing speech. The system may propose the character-set “*rowd” wherein the character “*” representing the beginning (e.g. predefinely) precise character (e.g. in this case “c”) of the word. Accordingly, by considering the same FIG. 6, in order to enter the word “naomi”, after the user presses the corresponding keys, the system may propose the word “crown”. The user may press the correction key and say the letter “n”. The system may propose the word “naked” (e.g. or the character-set “*aked” wherein the character “*” representing the precise character (e.g. in this case the letter “n”) of the word. Then, the user may press the correction key without providing speech. The system may propose the character-set “*aomi” wherein the character “*” representing the beginning (e.g. predefinely) precise character (e.g. in this case “n”) of the word.

As mentioned earlier, other precise characters of the proposed word may be shown in the same manner.

As described previously, according to one embodiment of the invention, during the correction procedure, the user may provide (e.g. by saying) more say more than one precise character of the word. According to one embodiment of the invention, when the system proposes a word (e.g. a chain of characters including the character(s) representing the precise character), if the user speaks a letter, said speech predefinely may correspond to the next ambiguous letter of the proposed word (e.g. chain of characters.).

According to another embodiment of the invention, during the correction procedure of the invention, if the words corresponding to the input information provided by the user have the same beginning characters, (e.g. in addition to the precise characters) the system may replace the (e.g. beginning) characters of the proposed word (e.g. chain of characters) by said predefined characters (e.g. “*”). For example, in the FIG. 6, by considering the keypad 16000 and the portion 16009 of the words of the dictionary of the system, in order to enter the word “crowd”, after the user presses the corresponding keys, the system may propose the word “crown”. The user may press the correction key without providing speech. The system may understand that the desired word begins with the letter “c”, and may propose the character-set “****d” wherein the characters “****” representing the beginning characters (e.g. in this case becoming precise characters of the words “crown” and “crowd” both beginning with the character-set “crow”) of the words beginning with the letter “c”, and having three more similar characters.

According to one embodiment of the invention, the user may provide a predefined interaction such as a predefined pressing action on a (e.g. same or different) correction key and say a character, wherein said speech may correspond to the (next) first non-similar character of the several words corresponding to the user's input information and having the same beginning characters. In the example above, providing such interaction with such correction key and saying a letter (e.g. “d”), the system may understand that said speech corresponds to the last letter of one of the words “crowd” or crown” (e.g. in this case preferably, the word “crowd”, because the word “crown” has higher priority and preferably may have been shown earlier to the user). According to one method of presenting in a predicted word, such character may blink on the screen so that the user may know where is the location of the character (e.g. within the desired word) of the desired word to be spoken

According to one example, by considering the portion 16008 of the database, pressing the keys 16002, 16001, 16002, 16002, may correspond to the words:
that
text
tear
   that begin with the same letter “t”. The system may first propose the word “that”. In order to enter the word “tear”, the user may press the correction key without speaking. The system may show the word “text” but also while blinking the letter “a” that indicates to the user that if he desires to enter the next letter beginning with the letter “t”, he preferably may say the third character of the desired word, because the previous characters of the desired word are similar to the current presented word. In this example, the user may press a predefined correction key and say the letter “x” so that the system presents/selects the word “text”.

According to another embodiment (of the correction method) of the invention, the beginning character and/or (each of) the precisely entered character(s)/letter(s) of the predicted word may be presented separately from the ambiguous characters of said word. In the example above, as pressing the keys 16002, 16001, 16002, 16002, may correspond to the words:
that
text
tear
   that begin with the same letter “t”. The system may first propose the word “that”. In order to enter the word “text”, the user may press the correction key without speaking. The system understands that the desired word should begin with the letter “t” (predefinely, becoming a precise letter of the word). The system may select the next word corresponding to the user's input information (e.g. the word “text”) and show it in two separate portions, “t” and “ext”. The separation method may be a predefined providing a predefined separating method such as providing a separating character (e.g. “_”) or the portions may be on different lines, different colors, etc. The user may confirm that the combined portions is the desired word by proceeding to a confirmation procedure such as a space character (e.g. or other behavior such as providing an end-of-the-word signal).

As mentioned before, different methods of entering a precise characters such as a multi-tap system can be provided with the combined (e.g. including word predictive) data entry systems of the invention. Said multi-tap method may replace and/or be part of the system in addition to the other methods such as user's speech for the entry of precise characters as described in different patent applications by this inventor.

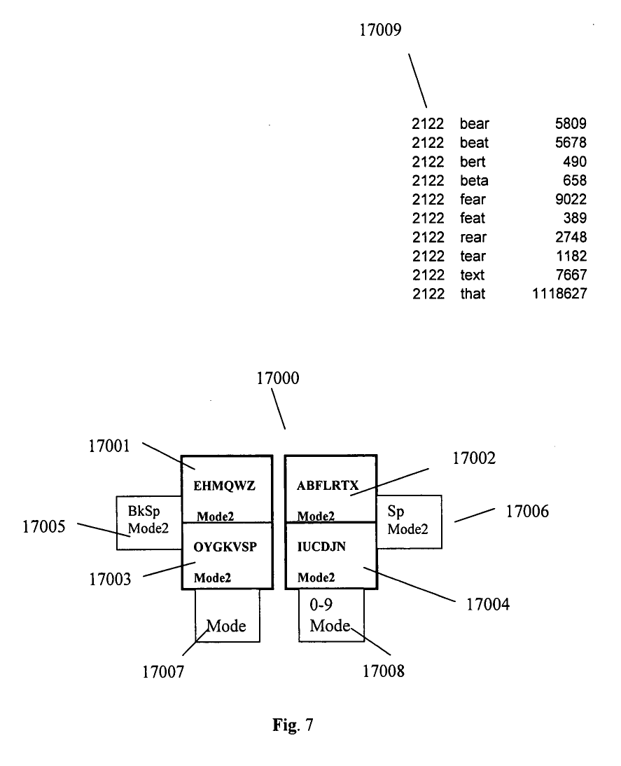

According to one embodiment of the invention, one or more “mode” keys may be used for entering a precise character (e.g. as a single character, or as a character of a word during the entry of a word). By providing a predefined interaction with a (predefined) key such as pressing and holding said “mode” key and providing multiple taps corresponding to a desired character (e.g. letter) on the corresponding (e.g. ambiguous) key, said desired letter may precisely be entered. For example, by considering FIG. 7, in order to enter the letter “f”, the user may press and hold one/any of the “mode2” keys of the keypad 17000 and press the key 17002 three (consecutive) times (e.g. multi-tap system) (e.g. predefinely, corresponding to the location of the letter “f” (e.g. in this case from left right) among the other characters of the said key). (e.g. a multi tapping system for entering a precise character is known by people skilled in the art).

Obviously, the precise character entered through the above-described multi-tap system can be used will all of the entry and correction methods of the word predictive data entry systems of the invention to replace and/or being-combined with the use of other methods such as speech, full (miniaturized) keyboard, or handwriting methods to enter a precise character in the combined data entry systems of the invention. For example, by considering the keypad and the (portion of the) dictionary of words of the system shown in FIG. 7, in order to enter the word “fear”, after entering the letter “f” by the multi-tap procedure as described above, the user may release the “mode2” key (e.g. removes his finger from the key) 17002, and (single) presses the keys corresponding to the remaining (e.g. ambiguous) characters (e.g. “ear”) of the word “fear”. By considering the precise beginning letter “f”, and the key presses corresponding the remaining characters, the system provides the word “fear” that has the highest priority among the words corresponding to the user's input information.

It is understood, that in order to distinguish between the mode (e.g. “Correction) key (e.g. 17007, 17008) corresponding to the entry of a precise character of an ambiguous key (e.g. 17001-17004) as described in previous patent applications (including the previous provisional patent applications of this series) filed by this inventor, and the entry of a precise character of an ambiguous key (e.g. 17001-17004) by using a mode key (e.g. 17005) and the multi-tap system just described, preferably predefinely two different “mode” keys may be used. This also permits the system to distinguish between the correction method of the invention and the multi-tap procedure of the invention. As an example, if the user desires to enter the word “feat”, after providing the input information (e.g. key pressing actions as described for the entry of the word “fear”), the system may propose the word “fear”. Then the user may press the Mode/“correction” key (e.g. 17007) once (without speaking) and the system may propose the next word corresponding to the user's information which in the example of the FIG. 7 is the word “feat”.

Obviously, the predefined (e.g. key) interaction combined with the multi-tap action to inform the system that said multi-tap action is used in order to enter a precise character, may be of any kind such as a another type of pressing/gliding action on the corresponding mode key, speech or handwriting command, through interaction with a full (minaturized) keyboard, etc.

In the multi-tap method used for the entry of a precise letter as described before, if two consecutive characters to be entered are not on a same key, the user may press-and-hold the first key (e.g. the “mode2” key) and provide corresponding multi-tap actions on the key corresponding to the first desired character, and continue to keep the first key (e.g. the same “mode2” key) in press-and-hold position (e.g. does not release the first key) and provide multi-tap actions on the keys corresponding to the second desired character.

On the other hand, if two consecutive characters to be entered are on a same key, for each of said characters, the user may provide a separate, press-and-holding action on the first (“mode2”) key along with corresponding multi-pressing on the key of the corresponding character.

As mentioned before, different methods of entering a precise characters can be provided with the combined (e.g. including word predictive) data entry systems of the invention. Said method may replace and/or be part of the system in addition to the other methods such as user's speech for the entry of precise characters as described in different patent applications by this inventor.

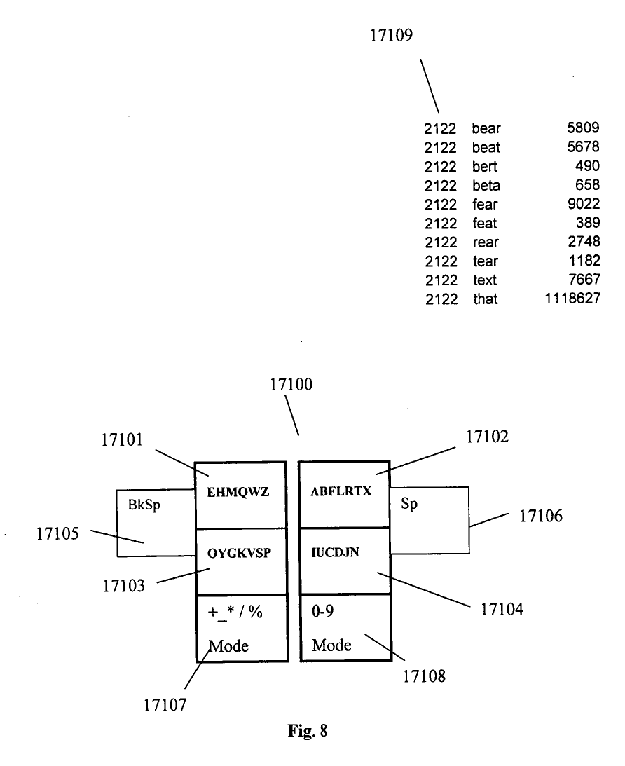

According to one embodiment of the invention, said method of entering a precise character may include/be-based-on long pressing action (e.g. press-and-holding action) on at least a (corresponding) key (e.g. long pressing action on a key for entering a precise character among a group of characters on a key, is known by people skilled in the art. For example, when the user press-and-holds a key (e.g. for at least a predefined laps of time), the characters/letters on said key may be proposed to the user (e.g. shown on the screen) one-by-one, generally, after a predefined laps of time between each two characters. When the user releases said key, the character displayed on the screen at that, time, will be entered.). As an example, by considering FIG. 8, in order to enter the word “rear”, the user may press-and-hold the key 17102. After a predefined laps of time, the system may understand that the user intends to provide a long pressing action, and it begins to propose/show the characters (e.g. letters) on said key one-by-one based on a predefined order (e.g. according to this/one example (e.g. from left to right), “a” then “b” then “f”, . . . and so on) to the user. When the system reaches to the letter “r” and proposes it (e.g. shows on the screen), the user may release the key 17102. The system may select the letter “r”. then the user may tap/press on the keys corresponding to remaining letters “ear” of the word “rear” (e.g. and then, eventually provides an end-of-a-word signal such as entering a space character). By considering the input information provided by the user, the system selects the word “rear” which in this example is the only word of the dictionary of the word 17109 that corresponds to said input information.

The same method may be used to precisely enter any character on/of any key. For example by considering FIG. 8, in order to enter the character “*” on the key 17107, the user may press and hold the corresponding key 17107. The system may propose the characters “+”, then “_” then “*”. At this time the user may release the key 17107. The system enters said letter. In the example of FIG. 8, the same rule may be applied to for the entry of any of the digits 0 to 9, etc.

The same method may be used for the entry of the characters when using the “mode” key. In the example of the FIG. 8, for example in order to enter the letter “F” (e.g. in uppercase) the user may press a mode key (e.g. 17107) and press-and-hold the key 17102. The system may propose the letters on said key as described before but in uppercase. When the system proposes the letter “F”, the user may release the key 17102 (and/or 17107). The system may enter the letter “F”.

It must be noted that in any of the methods (such as the multi-tap and/or long-press, as described) for the entry of a precise character, the proposal order of the characters may be dynamically defined by the user during the data entry. For example, the user may inform the system that when he provides a long pressing action on a desired key, he wants the system to propose the corresponding characters on said key from right to left, or vise versa. For this purpose, the user may provide a predefined interaction such as an additional interaction (e.g. key, speech, etc.) along with said long key pressing action. For example, in the examples above, a, single-press and holding, action (e.g. on the key corresponding to the desired character) may inform the system to propose the corresponding characters on said key one-by-one from left to right, and a, double-press and holding, action (e.g. on the key corresponding to the desired character) may inform the system to propose the corresponding characters on said key one-by-one from right to left. This is may be useful when the desired letter on a key (such as the letter “w” on the key 17101) is closer to the end of the list of the letters on said key. in the example above, if the user provides a, double-press and holding, action on the key 17101, the user may inverse the predefined proposal order (e.g. “z”, then “x”, then “q” . . . and so on) to make the entry of the letter “w” faster. According to another example, said order of presentation may be based on the priority (e.g. from highest to lowest) of the letters of the/a key relating to each other.

Methods of the entry of a precise character/letter and preferably, using them with the word predictive data entry systems of the invention as described in this and other patent applications filed by this inventor, are described as examples only. It is understood that other methods may used for the same purpose. For example, according one method, instead-of/in-addition-to press-and-holding action on a corresponding key for entering a desired character, the user may use glide-and-holding action (e.g. on the corresponding key). According to one embodiment glide-and-holding action from left to right on the corresponding key may cause the system to propose (e.g. show on the screen) the corresponding characters (of the key), one by one, beginning from left character to the right character, and glide-and-holding action from right to left on the corresponding key may cause the system to propose said characters one to one, beginning from right character to the left character.

It must be noted that although for the entry of a precise character of each group of characters of a key having several groups of characters (e.g. lowercase letters, uppercase letters), a different type of interaction have been described above, it must be noted that said types of interaction have been show and described as an example for the entry of a precise character of said group. Obviously, the general idea is that (for the entry of precise characters) to use a different type of interaction for each group of characters on a key such that the system may know to which group of characters the user's interaction is intended to.

Additionally, an additional different type of press-and-holding action (e.g. with the key(s)) may inform the system to repeat a character of a key. For example, the user may provide a predefined pressing (e.g. and eventually holding) action on a first key (e.g. a mode key) and press and hold the key (e.g. a second key) corresponding to the desired character so that the system proposes (e.g. on the screen) the corresponding characters on said key one-by-one (as described before). At the time when the system proposes (e.g. prints on the screen) the desired character, the user for example, may release the first (e.g. the mode) key and continue to keep the second key in pressing position so that to inform the system to repeat said letter (e.g. on the screen). the system may repeat said character until the user releases said second key. At that time the system may stop to repeat said character.

It must be noted that obviously any word (e.g. included or not-included) within dictionary of the system, may be entered by entering its characters, precisely, character by character, through the methods of the precise character entry such as the ones described above.

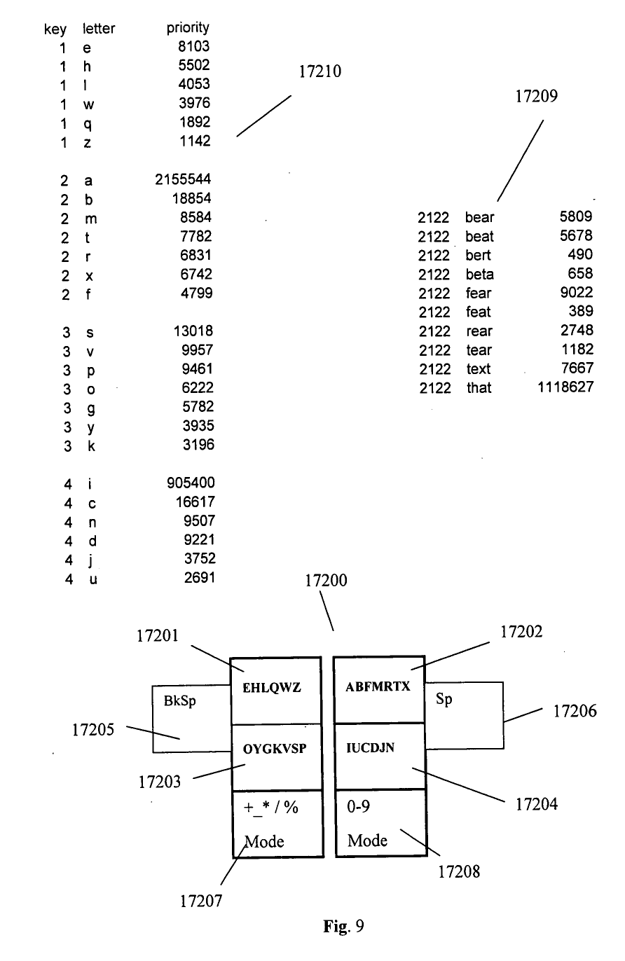

As mentioned in different patent applications field by this investor, the data entry system of the invention may be integrated within a device having an extendable/retractable flexible (e.g. plastic) display, wherein according to one embodiment of the invention, the keys of the keypad of the invention may be split in two groups and integrated within the device having said display unit, and wherein when said device/display is in retracted position, each of said group of keys is on a different side (e.g. on opposite sides) of said extended display/device. Obviously, said display may be retracted by any means/forms such being folded, slided, etc. accordingly, it may be expanded by any means/forms such as being unfolded, unslided, etc. With continuous embodiments of using different methods for the entry of a precise letter (e.g. during the entry of a word) through the combined (e.g. including predictive) data entry system of the invention, it must be noted that said precise letter(s) may be entered at any location within the word. For example, based on the keypad 17200 and the dictionary of words 17209 of the FIG. 9, in order to enter the word “text”, the user may first press the keys 17202 and 17201 corresponding to the beginning letters “te” of the word “text”. He, then, may provide a long-pressing (e.g. press-and-holding) action on the key 17202. The system may show (e.g. stream) one-by-one a group of characters on said key (e.g. one by one, the letters on said key) to the user. For example, the system may (begin to) show the letters one by one based on their priority (see table 17210) relating to each other (e.g. a, b, m, t, r, x, f). The user may release the key when the system shows the letter “x” (e.g. in this example, the letter “f” may not be shown because the user stops the streaming at “x”). This informs the system that the letter “x” must be entered precisely at that (e.g. third) location within the desired word. Then, the user may press/tap on the key 17202. By considering the input information provided by the user the system may enter the word “text” which in this example is the only word corresponding to the user's input information.

As mentioned before, the long pressing action for the entry of a precise letter may also be used in the correction procedures of the invention to replace the use of speech, or as an additional means of input information (e.g. the system may also include the press and speak means for the entry of a precise letter) for providing correction procedure when the use of speech is not desired. For example, after the user provides the (e.g. initial) input information (e.g. key presses, and eventually speech if desired/required in case it is also implemented with the system) for the entry of a word, if the system proposes a none-desired word, the user may press and hold a predefined key such as a correction key (e.g. a, as described in different patent applications filed by this inventor, a press-and-holding action with a key may be a predefined interaction such as a single/double pressing/tapping/gliding action on said key and keeping said key in pressing position (e.g. not removing the finger/stylus from the key for at least a predefined laps of time.), or a press-(e.g. and-holding) action (e.g. as described) on a first predefined key and a predefined press-and-holding action (e.g. as described) on said (e.g. second) key. These matters have already been described in different patent applications filed by this inventor). The system may propose, one by one, a word among the words of the dictionary of the system corresponding to the user's input information and beginning with a different character of the group of characters of the key corresponding to the first character of the desired word (e.g. one word per one different beginning character), wherein preferably, said word having the highest priority among the words of the dictionary of the system corresponding to the user's input information and that begin with said (different) character.

When the system shows a word that begins with the same letter/character as the desired word, then the user may release the (correction) key. The system proposes said word. If that word is not the desired word, then the user may provide a predefined (e.g. single) pressing/tapping action on a predefined (e.g. preferably, the correction) key. The system may show/propose a next word corresponding to the user's initial, and additional input information (e.g. word beginning with the same character as the proposed word), and wherein said next word preferably having the next highest priority among the words of the dictionary of the system corresponding to the combined (initial and additional) user's information (e.g. proposing a word based on the initial and additional information provided by the user have already been described in detail during the description of the correction procedures of the press and speak data entry systems of the invention).
on one hand, if the new proposed word is still not the desired word, the user may repeat the pressing/tapping action (e.g. without holding) on correction key (e.g. or another predefined key). The system proposes the word corresponding to the combined information as described, wherein said word has the next highest priority relating to the previous proposed word, and so on.
on the other hand, if the proposed word is the desired word, the user may inform the system by a predefined interaction such as providing an end-of-a-word signal such as entering a space character.

It must be noted that during the correction procedure, when the user provides the press-and-holding (e.g. long pressing) action on a predefined (e.g. “correction”) key, instead of proposing one by one a word as described, the system may propose one by one, the characters of the key corresponding to the beginning character of the desired word. After selecting the precise character by the user, the system may propose the/said corresponding word (e.g. based on the principles as described above).

Using the long pressing action for entering precise character during text entry and/or the correction procedure, perfectly integrates within the (predictive) data entry systems of the invention using press and speak. This combination provides a unique system. The long pressing action for the entry of a precise letter without speaking does not conflict with tapping action required for the entry of a precise letter requiring speech. Therefore their combination may not change the user's behavior when using his speech with the system. The user at any moment during the entry of the text can enter a character or a word with or without speaking, without being obliged to switch between two separate systems/modes. As an example, on one hand, the user may enter a precise letter of a word that is included within the dictionary of words of the system, by using the long pressing method (e.g. without speaking), and on the other hand, he may enter another word that is not included within the dictionary of the system, for example, character by character, by using the press (e.g. tap) and speak data entry system of the invention.

It must a noted that even the repeating procedure without speaking may be integrated within this combined “speech/none-speech” system without changing basic interactions with the (e.g. predictive) data entry systems of the invention combining press-and-speak and long pressing action for the entry of precise characters, or words For example:
the user may press (e.g. and hold) a first predefined key such as the/a “mode” key and provide a pressing-and-holding (e.g. long pressing) action on a second key corresponding to the desired character (e.g. that the user intends to repeat), as described before for selecting a precise letter, then providing a predefined interaction such as releasing the first key, may inform the system that the user intends to repeat said precise letter. The system repeats said letter until the user releases said second key. If the system is in “CapsLock” mode, the/said character may be repeated in uppercase (e.g. “MMMMM), if not it may be repeated in lowercase (e.g. “mmmmm”).

Note that, alternatively, the user may continue to use the repeating procedure used with the press and speak methods to the data entry system as explained before in detail.

The system may include a feature to permit to the user to decide the speed of the presentation of the characters to the user (e.g. on the screen) during the long pressing (e.g. press-and-holding) procedure. For example, a beginner user may want the characters to be displayed (one by one) slowly, and an expert user may want them to be displayed faster.

As an example of the preferred embodiment, by considering the FIG. 9, for example, the user may at least provide (e.g. any/some of) the following tasks (or additional task not listed below):
according to one method, in order to enter the word “feat” without speaking, the user may press-and-hold the key 17202 until the letter “f” is proposed to the user. At this time the user may release the key 17202, and then taps on the keys 17201, 17202, 17202 corresponding to the remaining letters of the word “feat”. The system may propose the word “fear” corresponding to the user's information (e.g. the initial information). Then, the user may press/tap (once) on the “correction” key. The system may propose the word corresponding to the user's initial information and having the next highest priority. Said word is the word “feat”. The system proposes said word and the user confirms it.
according to another method, in order to enter the word “feat”, the user may first press the keys corresponding to the letters to said word (e.g. the initial information). The system may propose the word “that” having the highest priority among the words corresponding to the user's input information. Then, the user may press-and-hold the correction key. The system may propose to the user, one to one, the words of the dictionary corresponding to the user's initial information and wherein each of said words begins with a different letter of the first key that was pressed during the initial input information, and wherein each of said words having the highest priority among the words having the same input information and beginning with the same character (e.g. this matter was described above). In this example, said words may be “bear”, “fear”, “rear”, and “that”. When the system shows the word “fear” (e.g. beginning with “f”), the user may release the correction key. Said word is selected but is not the desired word. At this time the user may provide a single pressing/taping action on the correction key. The system may show a next word corresponding to the user's initial information and having the same beginning letter as the word “fear” and wherein said next word having the next highest priority after the word “fear”. Said word is the word “feat”. The system proposes said word and the user confirms it by for example, entering a space character.
in order to enter an out-of-dictionary word, such as the word “zoro”, the user may enter said word character by character, by pressing the key corresponding to each of the letters of said word and speaking the corresponding letter.
In order to repeat the letter “m”, The user may press-and hold a predefined key such as the correction/mode key and press-and-hold the key 17202 until the letter “m” is proposed to the user. At this time, predefinely, the user may release the correction/mode key and continue to hold the key 17202 in pressing position. The system repeats the letter “m” until the user releases the key 17202.

In order to repeat the letter “m”, the user may press-and-hold the key 17202 and say the letter “m”. The system repeats the letter “m” until the user releases the key 17202.

It must be noted that although preferably integrating the non-speech method of the entry of a precise letter may be combined with the speech-required method (used for the same purpose) so that the user does not have to switch between modes, obviously, the system may be designed such that those methods do not be implemented within a same data entry system, and therefore the user may use a switching means to switch from one system to another (e.g. from the (e.g. predictive) press and speak data entry system of the invention, to a predictive (e.g. using long pressing action)/multi-tap data entry system, and vise-versa.

It must also be noted that the order of proposing characters to the user based on the multi-tap/long-press as described, may be differently predefined. For example:
it may be based on the priority degree of the corresponding characters relating to each other (e.g. see table 17210 of FIG. 9), or:
it may be based on the priority of the corresponding word at the moment of the beginning of the long-pressing action, or:
alphabetical order, or:
etc.

The presentation of the letters to the user may be in a loop-liked procedure, such that after proposing the last corresponding characters to the user, if the user still does not select a letter (e.g. and continues to multi-tap or long-press the key) the system begins to show the characters from the beginning again.

According to one method, the system may include a feature to permit to the user to inverse the order of the presentation of the proposed letters. For example, if the user desires to inverse the order, he may before/along-with providing the multi-tap/long pressing action, press (e.g. and eventually hold) another key such as the back-space key.

It must be noted that as for the press-and-holding action, the multi-tap action may also be used with the correction procedure of the system. In order to not conflict with the “correction” key functions, the multi-tap action for selecting the desired letter (e.g. or the word beginning with the desired letter) as described for press-and-holding-action, may predefinely use another predefined key (e.g. Space/BkSp key, or another letter key) combined with the key representing the desired precise character. For example, in order to enter the letter “m”, the user may press (e.g. an eventually, hold) the key 17205, and multi-tap on the key 17202 until the letter “m” is proposed.

As mentioned before in different patent application field by this inventor, in addition or instead of the speech of the user, the word predictive data entry system of the invention may use other methods of data entry, such as a full keyboard (e.g. at least the letter keys are/being unambiguous), for entering precisely at least one of the characters of a word to be entered (The rest of the characters of the word may be entered by pressing the (ambiguous) keys of the keypad of the data entry system of the invention, as described). Said (full) keyboard may be an on-screen keyboard, or a physical keyboard of any kind such as a QWERTY keyboard.

It must be noted that although the above-mentioned method/device may be a cumbersome system requiring many keys, but there are many (types of) devices in the market that either already include or will include such full keyboards. An example of such devices include mobile devices having miniaturized and/or on-screen full keyboards, wherein the use of such keyboards for long and intensive text entry is impractical.

The data entry system of the invention may be integrated within such devices to permit easier and faster data (text) entry (e.g. if desired/designed without using speech) by using said keyboard along with the keypad of the system. For example, during the entry of a word through the word predictive data entry system of the invention, the user may enter, precisely, one or more of the (beginning, middle, or last) characters of said words by using said full keyboard, and press the ambiguous keys (of the keypad of the invention) corresponding to the rest of the characters of the word (e.g. the initial input information). Also, for example, if a word proposed by the system (e.g. based on the initial information) is not the word that the user intended to enter, then the user may enter one or more of the (e.g. beginning) characters of said desired word during the correction procedure (e.g. the additional input information), by for example, (e.g. providing a predefined interaction such as pressing (e.g. and holding) a correction key, to inform the system of the correction procedure, and) pressing the corresponding keys of the full keyboard.

As mentioned, this method of input may duplicate the use of (e.g. corresponding ambiguous key and) speech for entering precise characters and the correction procedure during the entry of word through the predictive data entry systems of the invention. The rest of the entry and correction procedures/principles (e.g. use of the correction/next alone for proposing next word) may remain as before. For example, after the entry of said one or more precise characters during the correction procedure, if the system still proposes a non-desired word, then the user may provide a pressing action (e.g. alone) on the/a correction key so that the system propose the next word corresponding to the user's combined (e.g. initial and additional) input information. Obviously, said full keyboard may be used in addition to or to replace the other methods such as speech for entering precise characters.

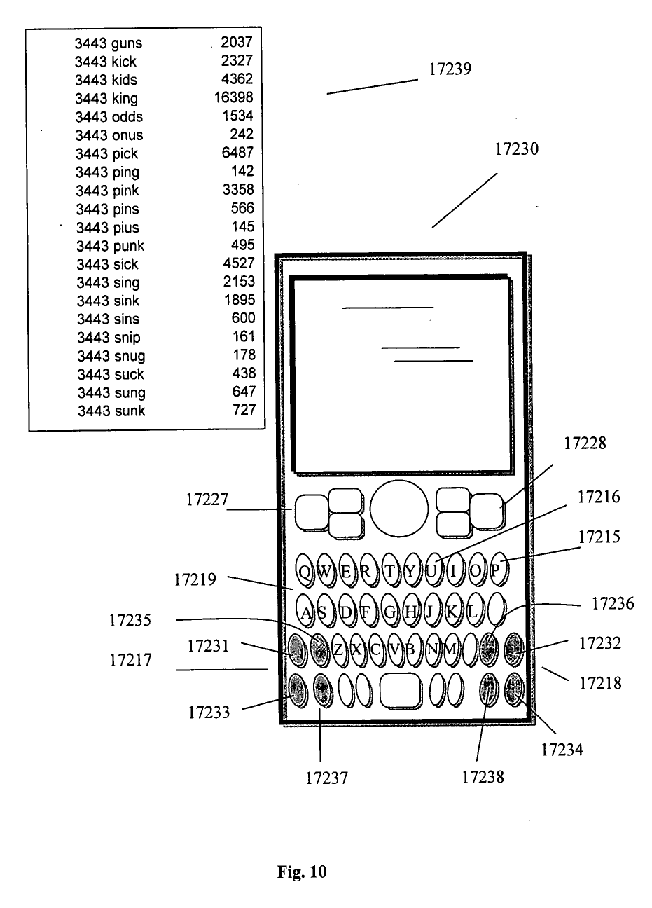

As an example, one such device 17230 is shown in FIG. 10, wherein two group of the keys 17217 and 17218 of the data entry system of the invention (in this example, keys 17231-17238 split in to groups, for example, duplicating the keys 17201-17208 of the keypad 17200 of FIG. 9) that in this example may include the (four ambiguous) letter keys of the invention, to be combined with the unambiguous keyboard 17219 of the QWERTY keyboard of the device 17230 for entering text/data. For example, by considering the dictionary of words 17239 in order to enter the word “pink”, the user may press the unambiguous key 17215 of keyboard 17219 (providing the letter “p”), and press the (ambiguous) keys 17234, 17234, 17233, of the keypad of the device/invention corresponding to the remaining characters “ink” of the word “pink”. By considering the first letter “p” precisely entered, and of the (ambiguous) key presses 17234, 17234, 17233, the system may propose the word “pick” having the highest priority among the words of the dictionary of the system corresponding to said input information. The user may provide a predefined (e.g. key) interaction such as pressing a predefined correction key (e.g. 17238). the system may propose the next word of the dictionary corresponding to the user's input information, wherein said word corresponding to said input information and preferably having the next highest priority relating the last proposed word. Said word is the word “pink”. The user may confirm said word.

According to another example, in order to enter the word “punk”, the user may press the (ambiguous) keys 17233, 17234, 17234, 17233, of the keypad of the device/invention corresponding to the characters of the word. By considering said (ambiguous) key presses, the system may propose the word “king” having the highest priority among the words of the dictionary of the system corresponding to said input information. the user may provide a predefined (e.g. key) interaction (e.g. to inform the system of a correction procedure) such as pressing a predefined correction key (e.g. 17238), and press the keys 17215, 17216, of the keyboard 17219 corresponding to two precise beginning letters of the word “pu” of the desired word “punk”. The system may propose a next word of the dictionary corresponding to the user's input information, wherein said word having the preferably having the highest priority relating to other words of the dictionary corresponding to said combined input information. in this example, there is only one word that correspond to the use's input information. said word is the word “punk”. The user may confirm said word.

It must again be noted that the full keyboard may also be split in (e.g. two) portions and be located on the sides of the device such that each portion to be closed to the user's corresponding thumb. Said keyboard is an on-screen keyboard, then, said each of said portions may be on the corresponding side (near the corresponding thumb) on the screen of the device. Preferably, the keys of the full keyboard may be small, and the keys of the keypad of the invention may be large. Also, preferably, the keys of the keyboard (split/none-split) may be arranged such that the keys representing the most frequent characters/letters being closed to the user's thumbs.

The system may also use any other means for the entry of precise letter(s), said means may be any type of keyboard (e.g. chording keyboard, half-QWERTY, Fitaly, shrunk keyboards (e.g. Fastap keypad), telephone-type keypad, etc.) and the predefined interaction procedure provided with the keyboard/keypad for the entry of the precise single characters.

It must be noted that the arrangement of the characters/letters on the (e.g. four) keys of the keypad of the invention may be such that to be based on the words of the dictionary of words of the system such that most of the words of the text provided through the system being provided without the need of entering precise characters, or the correction procedure.

Although the full keyboard may include punctuation characters and PC commands/functions, the keypad of the system may include at least the punctuation characters and PC commands/functions (e.g. at least those that do not require speech such that in case the system/user is not use speech they can enter them through the keypad, without speaking) as described in different patent application filed by this inventor.

The principle of such combined full keyboard and ambiguous keypad system may be based on using the keyboard as less as possible.

It must be noted that although in many paragraphs the keypad of the invention is shown in split form factor, obviously, the keys of the keypad may be closed to each other to for example, permit the usage of the keypad with the finger(s) of a single hand.

The system may use some of the keys of the (keyboard of the) device to perform/duplicate at least some of the keys of the keypad of the invention. For example, in FIG. 10 the keys 17231-17238 may be detachable/attachable keys or they may be part of the (full) keyboard of the device. Also in addition to the keys of the full keyboard, the device may have additional keys (e.g. 17227, 17228) that may be used for the same purpose (e.g. to duplicate at least some of the keys of the keypad of the invention).

It must be noted that obviously, at any moment during the entry of a text through the data entry system of the invention combining a (full) keyboard and the keypad of the invention, if the user desires, he may write a whole word (e.g. character by character, precisely) by using the full keyboard.

According to one embodiment of the invention, if the (full) keyboard for entering precise characters is a virtual (e.g. on-screen) keyboard (having small keys), during the entry of a word by the word predictive system of the invention, when the user presses on a key of said virtual keyboard to enter a precise letter of said word, it may happen that his finger touches more than one key. In this case the system may consider each of said more than one keys being pressed/touched and provide an input information for each of said keys (e.g. input information including said precise key) and the rest of key presses (provides through the keypad of the invention) of the word provided by the user. For example, if user's finger touches two keys while touching the full keyboard, and provides the ambiguous key presses corresponding to the remaining characters of the word, the system considers two input information, each including one of said characters). Then according to one example, the system may propose the word having the highest priority among the words corresponding to any of said both information.

Different methods of multi-tap systems have been described before. As mentioned before, and by referring to FIG. 8, according to one method the user may press (e.g. and hold) a first key (mode2 key, e.g. 17103) and provide multiple pressing actions on the key corresponding to the desired character. This matter have already been described before.

According to another method, the user may first press (and hold) the user may press (e.g. and hold) a first key (the key corresponding to the desired character) and provide predefined corresponding multiple pressing actions on a second key (a mode2 key). Said first press (and holding) action may be a predefined pressing action such as a single/double pressing/gliding (and holding) action, etc.

According to another method, in order to enter a precise character, the user may press (and hold) the key corresponding to the desired character. The system may map a predefined number of characters (e.g. the letters) on said key to a number of other keys (e.g. of the keypad). At this time, the user may provide a pressing action on the key wherein the desired character have/is been mapped. If there is only one character mapped to said key, then it is selected, but if there are more than one characters that are mapped to said key, then the system maps said characters to different keys (may include the same key). Then the user may press the key wherein the desired character is mapped. If the pressed key contains only one character mapped to said key, then it is selected, but if there are more than one characters that are mapped to said key, then the procedure will be repeated until the desired character is the only one that is mapped to a key so that the user selects it by pressing said key.

It is understood that according to one method, after the first mapping action, if there are more than one characters that are mapped to said key, the user may select the desired word, by providing a multi-pressing action on the mapped key corresponding to the desired letter. The predefined number of pressing actions may be based on different parameters such as the priority of the letter relating to other letters mapped to said key, etc. This matter has already been described in detail.

It must noted that in many paragraphs, pressing two keys (e.g. pressing (and holding) a first key, and pressing another key) have been used to describe a predefined interaction, It must be noted that obviously, any of said keys may be pressed first followed by (or simultaneously with the second key.

As for devices including a full keyboard, there are also devices that in addiction to the telephone) keypad include other keys. Said additional keys may be used to provide/duplicate at least a portion of the keypad of the invention, and said telephone keypad keys may be used for the multi-tap or mapping purpose for entering the precise characters.

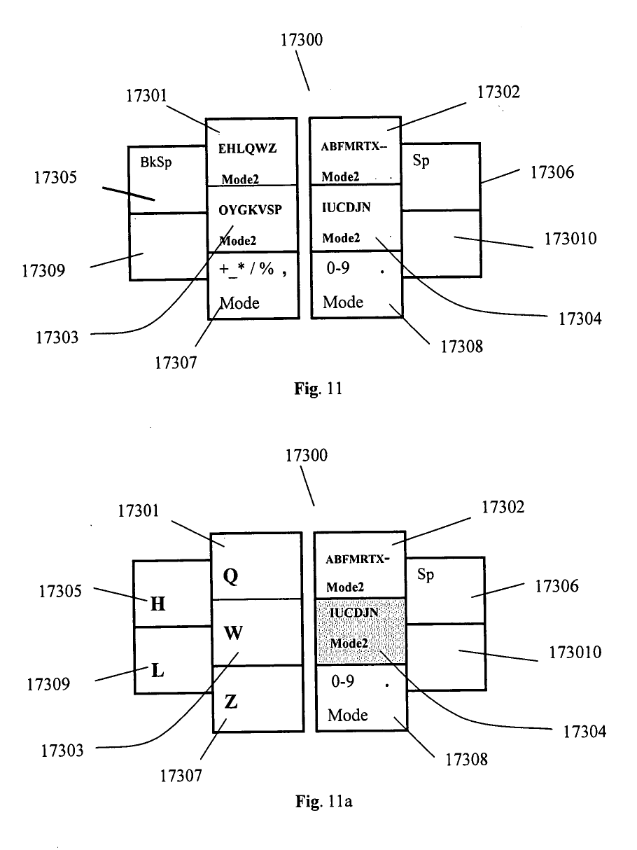

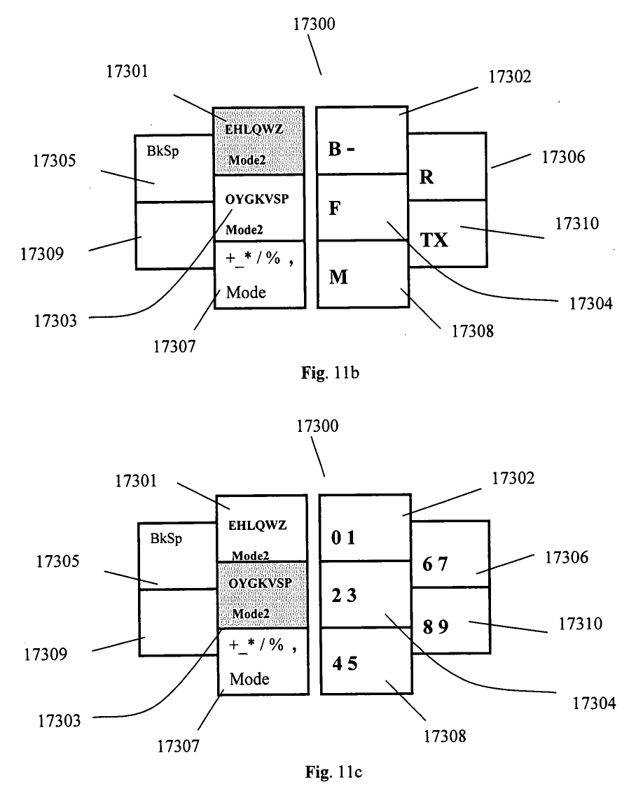

Different methods of entering precise characters (e.g. during the entry of a word through the predictive data entry systems of the invention) without providing speech have been described before. As described before, according to one embodiment of the invention, the keypad of the invention may be designed such that the user may press (e.g. and preferably holds) a first predefined key (e.g. preferably any of the keys other than the mode keys, such as the letter keys, may be considered as said first key. In FIG. 11 they are called Mode2 key so that to be distinguished from the mode keys) and press a second (e.g. ambiguous) key corresponding to a desired character (e.g. a letter), the system may predefiemly map at least some of the characters (e.g. such as the letters) of said (ambiguous) key onto different keys of the keypad. The mapping procedure may be such that each of the keys to which said characters are mapped contain few of said characters (e.g. preferably one character). Then the user may provide a predefined pressing action on the mapped key corresponding to the desired character to enter said character. Also for example, if the key that the desired character is mapped to contains more than one mapped characters, then, in order to enter the desired character, the user may for example provide a multi-tap/glide (e.g. single, double, etc.) procedure for selecting the desired character.

According to one embodiment of the invention, when the user provides the pressing (e.g. and holding) action on the first key and provides the pressing action on the second key (e.g. the ambiguous key corresponding to the desired character), the system may not map one of said characters (e.g. for example, the one having the highest priority among other characters on said key). Said character may be selected by default if the user releases the first key without pressing any of the mapped keys.

FIG. 11 shows as an example, a keypad 17300 of the invention wherein to four of its keys 17301 to 17304 the letters of English/Roman language are assigned. For example, if the user desires to enter the letter “e” he may press (and hold), for example, the key 17304 (e.g. a mode2 key when it is pressed and held) and (single) press the key 17301 that corresponds to the letter “e”. Then as shown as an example in FIG. 11a, the system may map the letters assigned to said key/key-interaction (e.g. in this example, except the letter “e” having the highest priority among said letters) to some of the keys 17301, 17303, 17305, 17307, 11309, of the keypad. At this time, if the user releases the key 17304, and the system provides the letter “e” by default. According to another example, in order to enter another letter such h as the letter “w”, (e.g. while pressing and still holding the key 17304 in pressing position), the use may press the corresponding key 17303 to which said letter is mapped.

As mentioned before, the system may map more than one character to a key. For example, the key 17302 may comprise seven letters “ABFMRTX”, and the special character “-”. As an example, when the user presses (and holds) a “mode2” key such as the key 17301 and provides a (single) pressing action on the key 17302, then as shown as an example in FIG. 11b, the system may map said letters and the special character (e.g. in this example, except the letter “a” having the highest priority among said letters) to some of the keys 17302, 17304, 17306, 17308, 11310, of the keypad. As an example, in order to enter the letter “t”, at this time the user single-presses the key 17310. Also as an example, in order to enter the letter “x” or the special character “-”, the user may double-press the corresponding key 17310 or 17302, respectively.

As mentioned before in many paragraphs, obviously, the above mentioned principles for the entry of precise characters may be used with the word predictive data entry and correction embodiments of the invention. As example, in order to enter the word “test”, the user may enter the letter “t”, precisely, as described above. He then may release the key 17301, and provide a single pressing action of each of the (ambiguous) keys corresponding to the remaining characters “est” of the word “test”. Based on the input information provided by the user the system proposes the word “test”, and the user may confirm it (e.g. providing a single pressing action on each of the (ambiguous) keys corresponding to the characters of the word “test” would provide the word “best” that has higher priority).

Said method of the entry of precise character(s) may also be used in the correction procedure of the invention. For example, if the user provides a single pressing action on each of the (ambiguous) keys corresponding to the characters of the word “test”, the system may propose the word “best” that having the highest priority relating to said key presses. At this time, the user may for example, provide a predefined type of pressing (e.g. and holding) action on a corresponding key (e.g. on a correction key) and if needed he may provide a (single) pressing action on the key corresponding to the first character of the desired word, and follow the mapping procedure as described above to select the desired letter “t” (e.g. if the user informs the system about only the first precise letter of the word, he may not have to again provide a pressing action on the key corresponding to the beginning letter of the desired word during the correction procedure, the system may enter to the mapping procedure based on said press (and-holding action of the correction procedure). Based on the initial information (e.g. ambiguous key presses), and the additional information (e.g. precise letter) provided during the correction procedure, the system may provide the word “test”.

If the user desires to precise/enter additional precise characters of the word such as the second, third, etc., of the beginning characters of the desired word during the correction procedure, then according to one method, for example, after selecting/precising the first character, without releasing the press-and-held key he may (single) press on the key corresponding to the next (e.g. second) character of the word, and follow the mapping procedure for selecting/precising it, and so on for the third character, etc.

Obviously, when more than one characters are mapped to a key, the character having the highest frequency of use among said mapped characters may be assigned to simplest interaction such as a single pressing action on said key (e.g. and, double press for the second highest priority character, and so on).

The principles explained above may be applied for the precise entry of other (ambiguous) characters of a key. For example, by considering FIG. 11, for the entry of one of the digits (e.g. 0-9) the user may press-and-hold the corresponding (first) key (e.g. 17303 in this example) and (preferably simultaneously) press the corresponding second key 17308. Then, as shown in FIG. 11c, the system may map the digits 0-9 on different keys (in this example, on five keys). Then (while holding the key 17303 in press-and-holding action), the user may for example, provide a single press on a desired key to enter a first digit on said key, and/or provide a double press to enter a second digit on said key.

Note that in many situations such as when the keypad is virtually and/or theoretically (e.g. dynamically) and/or physically/split in two portions (e.g. located on opposite sides of a device, as described as shown in the patent applications filed by the inventor) the user may use each portion of the keypad with a different thumb, therefore, the characters of an interacted (e.g. by user's first thumb) ambiguous key included within a first portion, may be mapped to the keys of the second portion (e.g. by user's other thumb)

It must be noted that instead of a press-and-holding action a user may provide another predefined infarction such as a gliding action. These matters have already been described in different patent applications filed by this inventor.

It must be noted that the examples given above, are provided for demonstrating the principles of the embodiments. Obviously, the mapping procedure may include any predefined type of interaction with at least one object such as a key, and wherein the characters may be mapped to any number of keys. These matters have already been described in detail in different patent applications filed by this inventor.

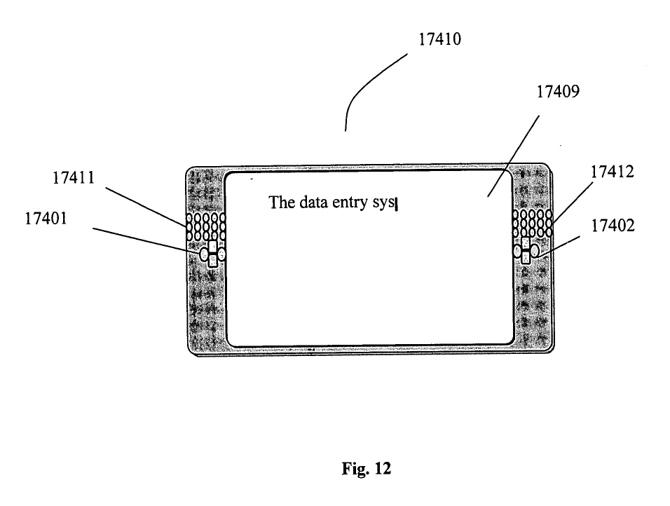

As mentioned before, it must again be noted that the full keyboard (for entering precise characters) used with the (predictive) data entry system of the invention may be split in at least (preferably) two portions and be located on the sides of a device such that each portion to be closed to the user's corresponding thumb. If said keyboard is an on-screen keyboard, then, said each of said portions may be on the corresponding side (near the corresponding thumb) on the screen of the device. Preferably, the keys of the full keyboard may be small, and the keys of the keypad of the invention may be large enough to be easily manipulated by the user. FIG. 12 shows an as example, a full (e.g. QWERTY) keyboard, being split in two portions 17411, 17412 and being located on the sides of a corresponding device such as a UMPC/PDA/SmartPhone/etc. and being combined/used with the (predictive) data entry system of the invention and its keypad (e.g. duplicating the keypad 17200 of FIG. 9) (e.g. also split in two portions 17401, 17402 on the side of the device 17410). In this example, the screen 17409 of the device is located between said split keys. The user may hold said device and (simultaneously) manipulate (the keys of) the device.

It must be noted that although said full keyboard is mentioned as a QWERTY keyboard, obviously, it may be any type of keyboard such as an “AZERTY” keyboard (French version of full keyboard), a keyboard wherein the letter keys that are used more often being closer to the user's finger, etc. Also the ambiguous keypad of the invention may be of any type and any kind, having any number of keys (e.g. telephone-type keypad), configuration of letters on ambiguous keys etc. These matters have already been described in detail in different patent applications filed by this inventor.

Obviously, said split full keyboard may be used to either replace the need of user's speech for entering precise characters, or as an additional means of entering precise characters, used during/with the (principles of) predictive data entry systems of the invention. The principles of (e.g. data entry, correction, etc.) the data entry systems of the invention based on providing ambiguous (e.g. through few keys) key presses and unambiguous characters (e.g. by at least one of the different means such as speech, full keyboard, handwriting/recognition, multi-tap, mapping procedures, etc.) corresponding to a word for entering said word, have already been described in detail in different patent applications filed by this inventor. Obviously, any other methods for providing said ambiguous information and unambiguous characters may be used by people skilled in the art to be used with the principles of the data entry system of the invention as described.

According to one embodiment of the invention, at least some of the (e.g. ambiguous) keys (e.g. at least the letter keys assigned to for example four keys) of the data entry system of the invention may use some of the keys of the full keyboard (e.g. QWERTY) that is used for the entry of precise character, during the entry of a word through the (predictive) data entry system of the invention. This means that a same key may be used for, both, entry of precise character(s) and entry of ambiguous key presses, corresponding to a desired word, during the entry/correction methods of the invention. This may for example, permit to use the keys of an existing device, also permitting to provide smaller new devices.

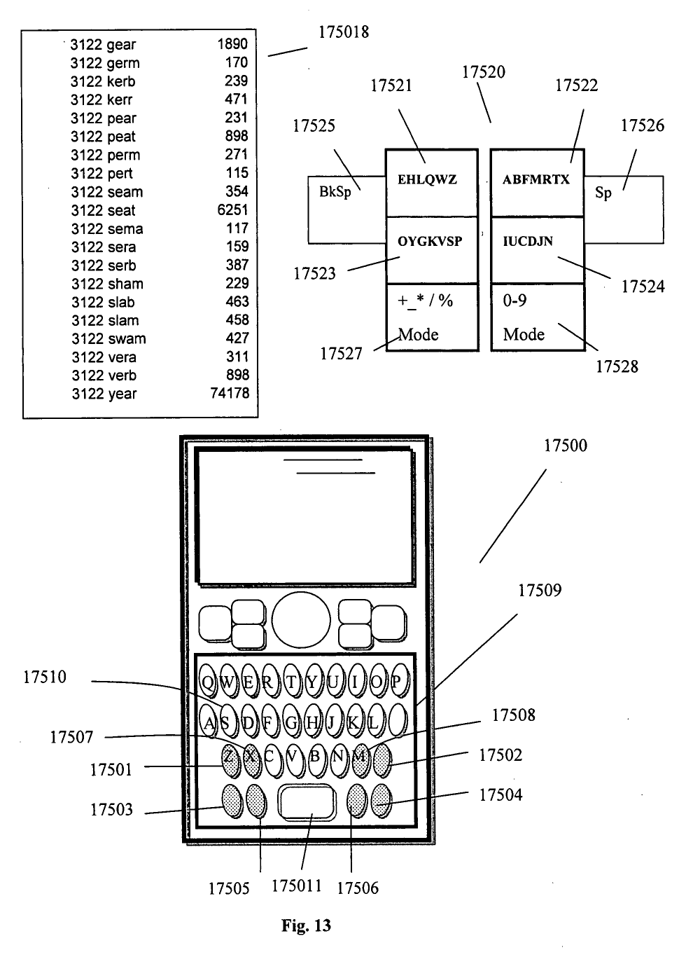

FIG. 13 shows a as an example, a mobile device 17500 having a small QWERTY keyboard 17509. Said device may include the predictive data entry system of the invention that may use said keyboard for the entry of the precise character(s) during the entry of a word. In addition, some of the keys 17501-17508 of said keyboard 17509 may also be used with the predictive data entry system of the invention to duplicate the (e.g. ambiguous) keypad of the invention as shown and described in many embodiments. At any moment (e.g. for example, during the entry of a word) a predefined (e.g. key) interaction may inform the system to consider said keys as the keys of the keyboard, or as the keys of the keypad.

According to one embodiment of the invention, when the user upload the system, said combined keyboard and keypad system are (e.g. by default) used with the data entry system of the invention. Preferably, at the beginning, by default, said keys 17501-17508 work as the keypad of the invention (e.g. duplicating respectively the keys 17521-17528 of the keypad model 17502 of the invention), unless otherwise instructed by the user.

As an example to show some of the principles described above, by considering FIG. 13, in order to enter the word “seat” the user may first press the key 17510 of the full keyboard to indicate to the system that the desired word must begin with the letter “s”. the user may then press the keys 17501, 17502, 17502, of the (e.g. ambiguous) keypad of the invention. By considering the corresponding portion of the database of the invention 175018 and based on the input information provided by the user (and priority), the system may propose the word “seat”, and the user may confirm it.

The user could also enter the same word by for example, pressing the keys 17503, 17501, 17502 of the keypad of the invention. Then, the user could provide a predefined interaction such as providing a predefined key interaction to switch the keys 17501-17508 from functioning as the keypad of the invention, to function as the corresponding keys of the keyboard 17509 of the device. For example, the user may press (e.g. and hold) a predefined key (e.g. such as the key 17505 of the keypad, or a key 175011 of the full keyboard), to inform the system to provide said switching action, and press the key 17502 to precisely enter the letter “t” corresponding to the last letter of the desired word “seat”. Based on the input information provided by the user the system may propose the word “seat”.

It must be noted that the user may provide a predefined interaction such as a predefined key interaction (e.g. in the example above, releasing the press-and-held key) to switch back said keys 17501-17508 to function as the keys of the (e.g. ambiguous) keypad of the invention.

According to another example, for entering the word “seat” the user may first press the (ambiguous) keys 17503, 17501, 17502, 17502, corresponding to the characters of said word. The system may provide the word “year” corresponding to said key presses, and having the highest priority. At this time the user may provide a predefined interaction such as providing a predefined pressing action on a predefined key to inform the system that it enters in the correction procedure (e.g. said pressing action may be a predefined interaction such a single-pressing action, a press-and-and-holding action, double-pressing action, etc. this matter has already been described in detail). The user then, may provide the precise letter(s) corresponding to the (e.g. beginning) character(s) through (e.g. by pressing the corresponding key of) the full keyboard, and if needed uses the correction key to navigate (e.g. based on the priority) within the words corresponding to the initial and additional information provided by the user, etc. (correction procedures of the invention have been described in detail, before).

In this example, after entering into the correction procedure, the system may preferably automatically switch to full keyboard mode, After entering in correction mode, the user may press the key 17510, to inform the system that the desired word must begin with the letter “s”. Based on the initial key presses and the additional information provided by the user the system may propose the word “seat”.

Obviously, in the embodiments above, if a word is not included within the dictionary of words of the system, said word may be entered character by character, through the full keyboard.

The principles of the above data entry system using a full keyboard, may also be applied to use of any other type of keyboard/keypad (e.g. using its corresponding system for entering precise characters), with the (ambiguous) keypad and (e.g. the predictive) data entry systems of the invention.

According to one embodiment of the invention, at least some of the (e.g. ambiguous) keys (e.g. at least the letter keys being assigned to for example four keys) of the (predictive) data entry system of the invention may use some of the keys of any (e.g. existing) device such as some of the keys of a telephone-type keypad of a device. As mentioned before, also, the (predictive) data entry system of the invention may use the input system (e.g. multi-tap) of said other (e.g. telephone-type) keypad used for entering precise characters.

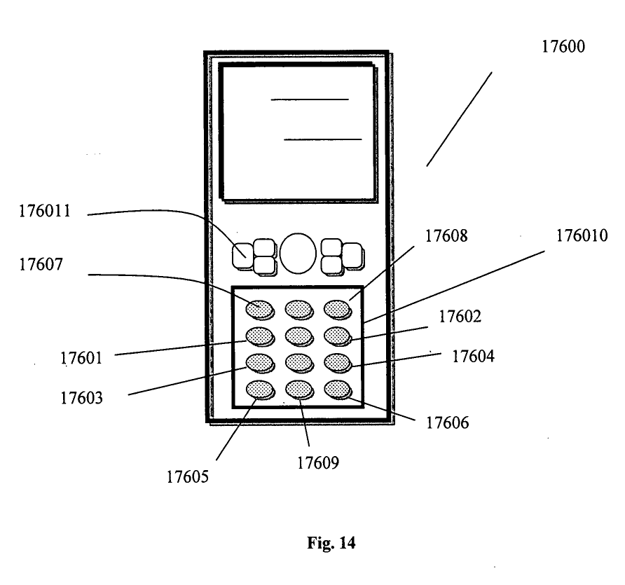

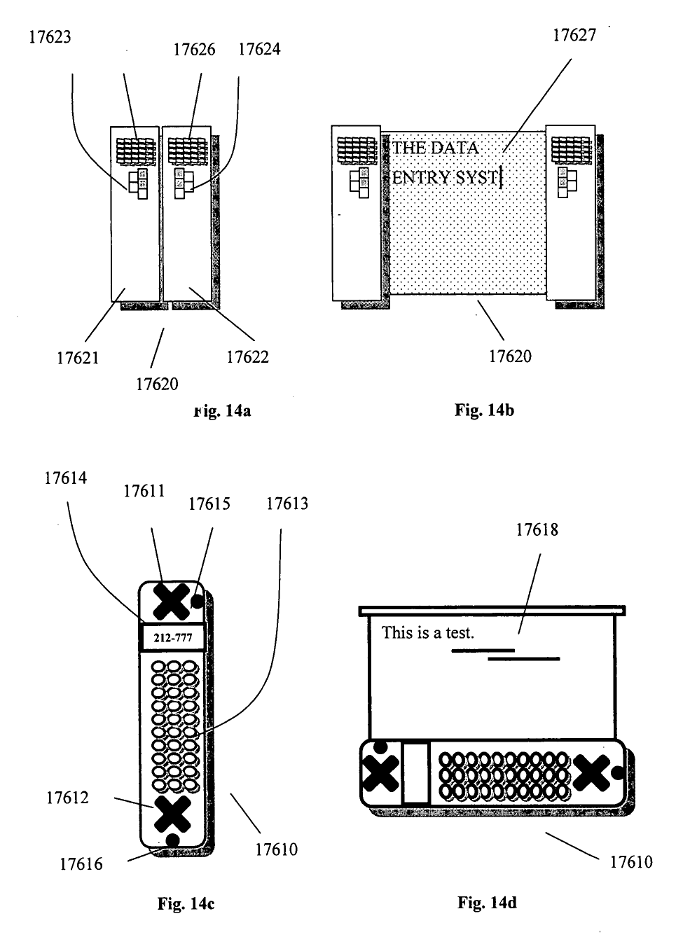

FIG. 14 shows as an example, a mobile device 17600 having a telephone-type keypad 176010. The data entry system of the invention may use some of the keys (e.g. 17601-17608) of said telephone-type keypad to duplicate for example, respectively the keys 17501-17508 of the keypad of the invention 17500 as shown in FIG. 13. The data entry system of the invention may also use the multi-tap method used with the telephone keypads for entering precise characters, in order to enter at least one of the precise characters/letters of a desired word during the entry of said word or during the correction procedure to enter said word, through the predictive data entry system of the invention. The principles of common keys between the keys of the telephone-type keypad and the keypad of the invention may be the same as used for the full keyboard.

As an example to show some of the principles described above, by considering the keypad of FIG. 14 and the dictionary of word 175018 of FIG. 13, in order to enter the word “seat” the user may first (e.g. and hold) a predefined mode key 17607 or 176011 (e.g. to enter to telephone-type keypad mode) and press four quick pressing actions on the key 17603 (e.g. multi-tap) corresponding to the letter “s” on said key, to enter precisely the letter “s” (e.g. the key 17603 corresponds to the key having the letters “PQRS” wherein to enter the letter “s” the user must quickly press four times said key. The principles of multi-tap method used with the telephone-type keypad are known by people skilled in the art). The user may then switch to the ambiguous keypad of the invention by for example, releasing said held key. then the user may (single) tap on the keys 17601, 17602,17602, corresponding to the (e.g. ambiguous) remaining characters of the desired word “seat”. Based on the precise (e.g. character) and ambiguous key information provided by the user, the system provides the corresponding word having the highest priority. Said word is the word “seat”. The system may propose it and the user may confirm it. Obviously. In the example above, when the system is in the telephone-type keypad mode, the arrangement/distribution of letters on said key was considered to resemble to the standard arrangement of the Roman/English letters on a telephone keypad.

Obviously, all of the principles of the predictive data entry/correction systems of the invention, using a full keyboard for entering precise characters during the predictive data entry/correction of the invention also using the keypad of the invention as described before, may be duplicated by using a telephone type keypad using the multi-tap method (e.g. or other (known) methods) to enter said precise characters, during the entry/correction of a desired word through the predictive data entry system of the invention (e.g. also using the keypad of the invention).

It must be noted that if a word is not included within the dictionary of words of the system, said word may be entered character by character, through the (e.g. the telephone-type keypad and its) multi-tap system. Obviously, said word may automatically/manually added to the database of the system.

It must be noted that the entry into the mode informing the system that the precise characters entered during said mode belongs to the correction procedure may be provided by any predefined interaction such as one of the following:
1. providing a press-and-holding action on a key (e.g. key down)
2. providing another type of interaction such as a predefined pressing/gliding action such as a single/double pressing/gliding action on a predefined key
3. etc.
   The user may exit the above-mentioned mode (e.g. after entering the precise letter(s), by respectively:
1. releasing said held key (e.g. said key, up)
2. providing again, said another type of interaction such as a predefined pressing/gliding action such as a single/double pressing/gliding action on said or on another predefined key
3. etc.

As previously shown in FIG. 12, the full (e.g. QWERTY) keyboard used with the data entry system of the invention, may be split in (e.g. two) portions and be located on different sides of the corresponding device. FIG. 14a shows an extendable device 17620 having a first portion 17621 and a second portion 17622, and being closed position. Said device also includes an extendable flexible display unit. Said type of device was already been described in different patent applications field by this inventor. the keypad of the invention having few keys, may be split in two groups of keys. 17623, and 17624 and each of said group of keys may be located on one of said portions of the device. Also, the full keyboard may be split in two groups 17625, and 17626 and each of said group of keys may be located on one of said portions of the device. FIG. 14b shows said device and its display 17627 in extended position. Said display may be made of flexible materials such as plastic so that to be rolled (e.g. within said device), wrapped (e.g. around said device), etc, when said device in closed position.

Also as an example, FIG. 14c shows an extendable device 17610 having an extendable display unit in closed/retracted position. Said device also includes an extendable flexible display unit. Here, the keypad of the invention having few keys may be split in two groups of keys 17611, and 17612 (e.g. being in form of two multi-intentional keys), and being located on opposite sides of the device. Said device also includes a full keyboard 17613 that may be used with the data entry system of the invention. The device may also have another display unit 17614, a microphone 17616, a speaker 17615, etc. and include telephony functionalities. FIG. 14d shows said device and its extendable display 17618 in extended position (e.g. in this example, extended from the longer side of the device). Said display may be made of flexible materials such as plastic so that to be rolled (e.g. within said device), wrapped (e.g. around said device), etc, when said display is in retracted position, it may be equipped/made such that to stay in a standalone flat position.

When said device in closed position. the keys of both, the keypad of the invention and the full keyboard may be arranged on said device such that to conform with the extendable display unit 17618. The keys of the keypad of the invention (e.g. in this example, each multi-intentional keys may duplicate five keys (four corners and the center)) and/or some of the keys of the full keyboard may duplicate the keys of a telephone keypad, so that when said device is in closed/telephony position they can work as a telephone keypad for dialing numbers. In this case, according to one method, said telephone keypad may preferably be be conformed (e.g. in direction of) the (small) display 17614.

The (word) predictive data entry system of the invention using a full keyboard, may be packaged such that to form a stand-alone data entry unit to interact wirelessly or by wires, with any type of (electronic) device.

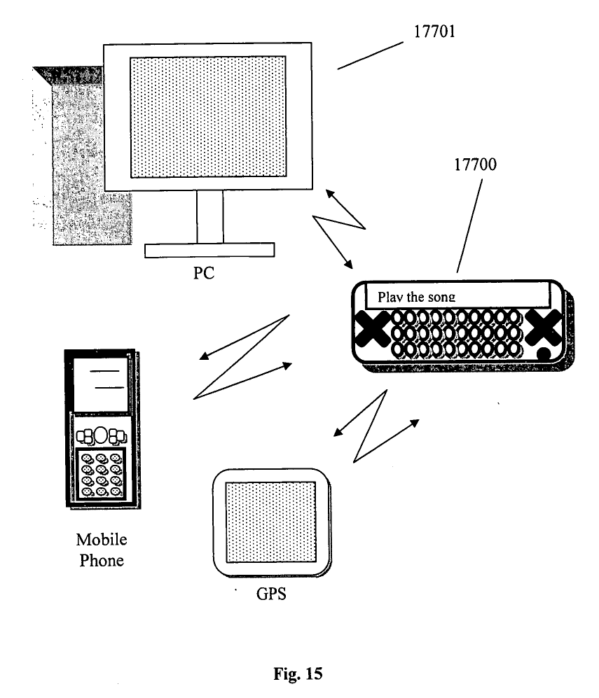

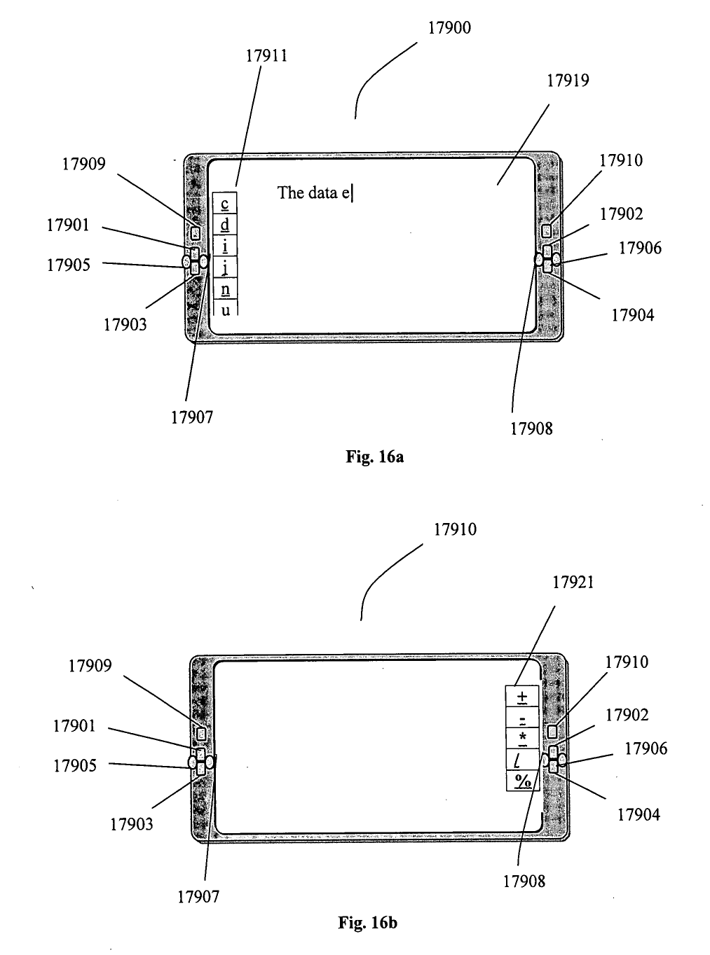

For example, as shown in FIG. 15, said device 17700 may be used as an external (mobile) keyboard of an electronic device such as a computer 17701, GPS, mobile phone, etc. According to one embodiment, the device may send the key presses (e.g. if used) provided by the user to the corresponding electronic device and the processing may be done within the electronic device. According to another method, the processing may be done within the data entry unit, and the result may be sent to the corresponding electronic device. the data entry unit may also include its own display unit so that to permit the user to see what he writes, so that he can be far from his computer.

As previously described and shown, the data entry system of the invention may include a method for entering precise characters without speaking. One of said methods that described is a mapping system wherein when the user provides a predefined pressing action on an ambiguous key, the corresponding characters on key may map to other soft/hard keys such that to each of said mapped keys only few of said characters (e.g. preferably one characters) being mapped such that by a simple pressing action (e.g. single/double tap/glide) on the mapped key the precise character being entered.

According to one embodiment of the invention, the corresponding characters of the predefined pressing action on an ambiguous key may be mapped to several (e.g. dynamic) on-screen keys. This matter have been discussed before and was shown earlier in FIG. 5a, and hereafter some more example of a preferred embodiment is described.

As an example, by considering FIG. 16a, an electronic device 17910 having the data entry system of the invention that uses few keys 17901-17910 that in this example respectively duplicate the keys 17301-173010 of the keypad 17300 of FIG. 11. As mentioned before, for example, in order to enter unambiguously the letter “d” the user may first press (e.g. and eventually hold) the key 17904. The system may show at least six on-screen keys 17911 each representing/corresponding to one of the letters represented by the key 17904 (e.g. there may be more on-screen keys to represent other characters represented by said pressing action on the key 17504). The user then may press the on-screen key corresponding to the letter “d”.

Obviously, the precise letter(s) entered through this embodiment may be used during the entry of the words through the predictive data entry system of the invention.

According to one method of the embodiment described above, each time the user presses an ambiguous (e.g. in this example a hard) key the system provides the corresponding unambiguous (e.g. soft/on-screen) keys. In this case:
if the user provides a pressing action on a corresponding unambiguous mapped (on the screen) key:
   the system provides the corresponding unambiguous character
if not (e.g. if the user provides a pressing action on a key other than said on-screen keys relating to said ambiguous key that was pressed by the user)
   the system considers said ambiguous key pressing action provided by the user.

According to one embodiment of the invention, if the characters of the predefined interaction with the ambiguous key are not part-of-word, then one of said characters may not be mapped on the screen, so that if the user provides the corresponding pressing action on a key, but does not press any of the mapped keys, then the system enters said character by default. As an example, as shown in FIG. 16b, if a user provides a predefined pressing action on the key 17907, the system may map the corresponding characters (except the character “,” on the screen. The user may enter any of said mapped characters by providing a pressing action on the corresponding mapped key. If not (e.g. after the user presses another hard key) the system may enter the default character “,”.

As mentioned before, several consecutive pressing actions on the mapped keys may provide several precise characters. For example, FIG. 16c shows the digits 0-9 being mapped on several on-screen keys, after the key 17908 being pressed. for example, in order to enter the number “1278” the user may press the key 17908, then he may press, consecutively, four mapped on-screen keys corresponding to the digits “1”, “2”, “7”, “8”.

Also the symbols assigned to a mode (key) interaction may be entered through this method. For example, the symbols (e.g. such as the lowercase letters) can be assigned to a single pressing action on a first key (e.g. and be mapped on the screen when said key is pressed), and same letters in uppercase may be assigned to a pressing (e.g. and holding) on a mode key and pressing said first key. in this case the system may map said symbols (e.g. letters in uppercase) on the on-screen keys (see the example of FIG. 16d) and the user may press the desired on-screen key.

The above-mentioned mapping method may also be used in correction procedure of the invention. For example, after the user provides the initial input information for entering a word through the predictive data entry system of the invention, if the proposed word by the system is not the desired word, then according to one method, the user may press a predefined key such as a correction key. The system may map on several (dynamic) on-screen keys, the characters that correspond to the provided initial key press corresponding to the first character of the desired word (e.g. preferably, one character per one on-screen key). Then the user may press said on-screen key to inform the system about the first precise letter of the desired word. According to one method, (e.g. immediately) after that, the system my map on several (dynamic) on-screen keys, the characters that correspond to the provided initial key press corresponding to the second character of the desired word. then the user if desires, he may press said on-screen key to inform the system about the first precise letter of the desired word, and so on.

Based on the initial and additional input information, the system may propose a corresponding word (e.g. based on the priority).

Obviously, as mentioned before, according to one method, after pressing on said predefined (e.g. correction key), the user may not press any of the corresponding mapped keys on the screen. In this case (e.g. after a predefined laps of time or by providing a predefined command/interaction) the system may propose the next word (e.g. based on the frequency) corresponding to the input information (e.g. initial, and additional if any) provided by the user (e.g. and so on if needed).

The user may provide one or more consecutive pressing actions on the unambiguous keys corresponding to one ambiguous key pressing action (e.g. to provide consecutive unambiguous characters).

When the ambiguous keys are split on opposite sides of a device, then preferably each pressing action on an ambiguous key provides the corresponding unambiguous (on-screen) keys on the opposite side of the device (e.g. closed to the user's thumb).

As mentioned before, the word predictive data entry system of the invention is based on using few (e.g. four) keys to enter ambiguous characters, (e.g. and when needed) combined with additional information provided through other means such as user's speech or a system providing precise character (e.g. qwerty keyboard, multi-tap system, handwriting, etc), during, or at the end of the entry of the word (e.g. correction procedure of the invention). It is understood that generally in order to enter a precise character during the initial input information a first predefined type of interaction may be used to enter said character, and during the correction procedure of the invention, a second predefined type of interaction may be used to inform the system about a precise character of the word entered/proposed through the initial input information (e.g. ambiguous keys (e.g. and unambiguous characters, if any was provided)). For example, according to one embodiment, the system may be designed such that when the user desires to enter a precise character during the entry the initial information of a word through the/a predictive data entry system of the invention, he may press a mode/shift key and press the desired key of the (qwerty) keyboard (e.g. also according to another example, alternatively, he may double-press the desired key of the (qwerty) keyboard). In this example, for example, a simple pressing action such as a single-pressing action on the desired key of the (qwerty) keyboard (e.g. without using a shift/mode key) may correspond to providing the (information about a) precise character of the word during the correction procedure of the invention.

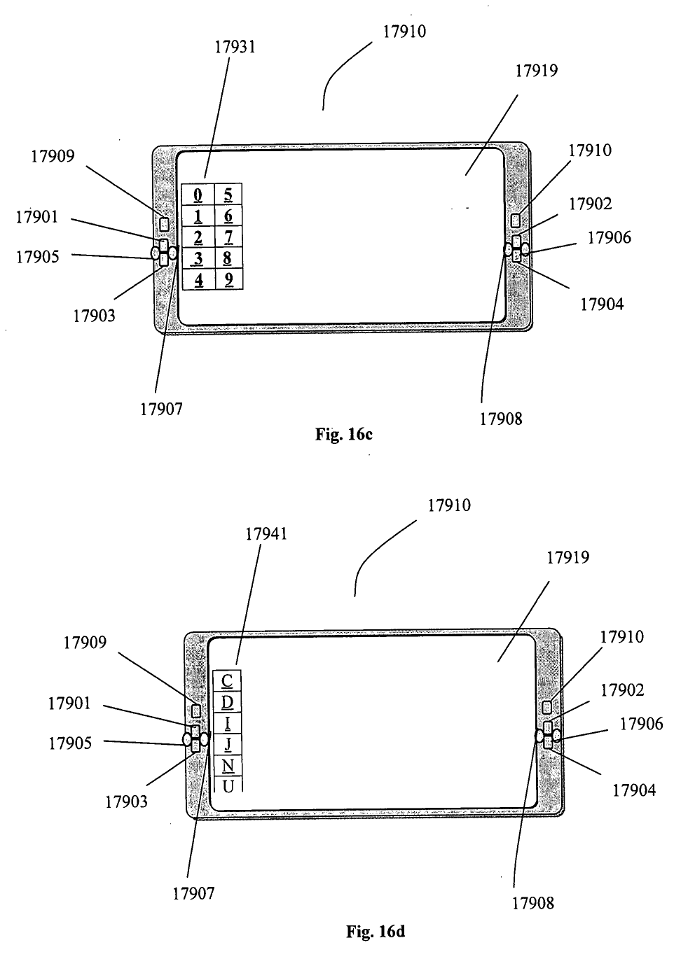

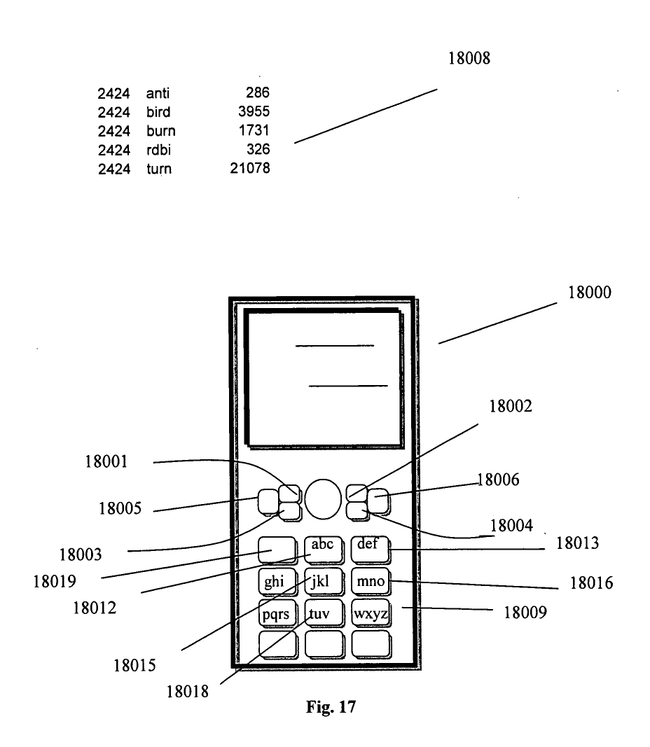

As mentioned, obviously any other method or keyboard may be used for entering said precise character/information during the entry of a word through the predictive data entry/correction systems of the invention. For example, said keyboard may be a telephone-type keypad and said method may be the multi-tap system. FIG. 17 shows as an example, a communication device 18000 having a keypad of the invention having (in this example) six keys 18001-18006 wherein four of said keys 18001-18004 duplicate the ambiguous keys 17201-17204 of FIG. 9. In this example, the precise characters during the entry/correction of a word may be entered through the telephone-keypad 18009 by for example using a multi-tap system (multi-tap system is known by people skilled in the art.) For example, by considering the portion 18008 of a dictionary of words of the system, in order to enter the word “bird”, the user may provide two consecutive pressing actions (double click) on the key 18012 of the telephone keypad 18009 to precisely enter the letter “b”, and then press the ambiguous keys 18004, 18002, 18004 corresponding to the remaining characters of the word “bird”. By considering the (initial) input information (e.g. precise character and the ambiguous key presses), the system provides the word “bird”. According to another example, the user may first press the ambiguous keys 18002, 18004, 18002, 18004 corresponding to the characters of the word “bird”. The system may propose the word “turn” having the highest priority among the words corresponding to said key presses (e.g. initial information). The user then may double press the key 18012 of the keypad 18009 (e.g. additional information) to inform the system that the first character of the desired word must beginning with the letter “b”. The system may propose the word “bird” having the highest priority among the words corresponding to said initial and additional input information. As mentioned before, in order to distinguish between the entry of a precise letter/character during the initial input information and during the correction procedure a different predefined (key) interaction may be used. For example, during the initial input information the precise character may be entered by interacting with (e.g. multi-tapping on) the corresponding key of the telephone keypad without combining a mode key, and during the correction procedure, the user may for example, press (e.g. and hold) a predefined (e.g. mode) key 18019 and interact (e.g. multi-tap) with the corresponding key of the telephone keypad (or vise versa).

Obviously, said/the keypad/keyboard providing precise characters may have any number of keys and any type of letter attribution. For example, the letters of a language may be assigned to twelve keys of a telephone-type keypad, and the letters assigned to a key of said keypad may be assigned such that a single pressing action on said key may provides the most commonly used letter, a double pressing action on said key may provide the next most commonly used letter, and so on.

(e.g. In the example above), instead-of/in-addition-to the multi-tap system for entering said precise character through an ambiguous key (e.g. of a telephone-type keypad) a system combining the user's speech may be used. According to one method, one of the letters (e.g. preferably, the most commonly used) of an ambiguous key may be entered by for example providing a (single) pressing on said key without providing a corresponding speech. Any of the other letters of said key may be entered by providing said pressing action and providing the corresponding speech (e.g. speaking said letter).

For example, by considering the telephone-type keypad 18009, a single-pressing action on the key 18012 without providing a speech may correspond to the letter “a”. In order to enter any of the other letters (e.g. “b” and “c”) on said key, the user may single-press on said key and say said letter. This is particularly efficient for better accuracy when entering characters/letters through a telephone-type keypad using user's speech, wherein a first letter of a each of the two of the letters, on a key, having ambiguously resembling (e.g. in this example voice-based) speech (e.g. “e, d” on the key 18013, “k, j” on the key 18015, “m, n” on the key 18016, “t, v” on the key 18018) may be assigned to a (single) pressing action on said key without providing speech, and the second letter of a each of the two of the letters, on a key, having ambiguously resembling speech, may be assigned to a (single) pressing action on said key and providing its predefined speech (e.g. speaking it). Obviously, if the speech recognition is lip-based or lip&voice-based, the corresponding assignments may accordingly be different.

According to one embodiment of the invention, the (predictive) data entry system helped by a full (e.g. qwerty) keyboard may be integrated with a (telecommunication) device such that to provide multi-function use of said device in an optimal manner.

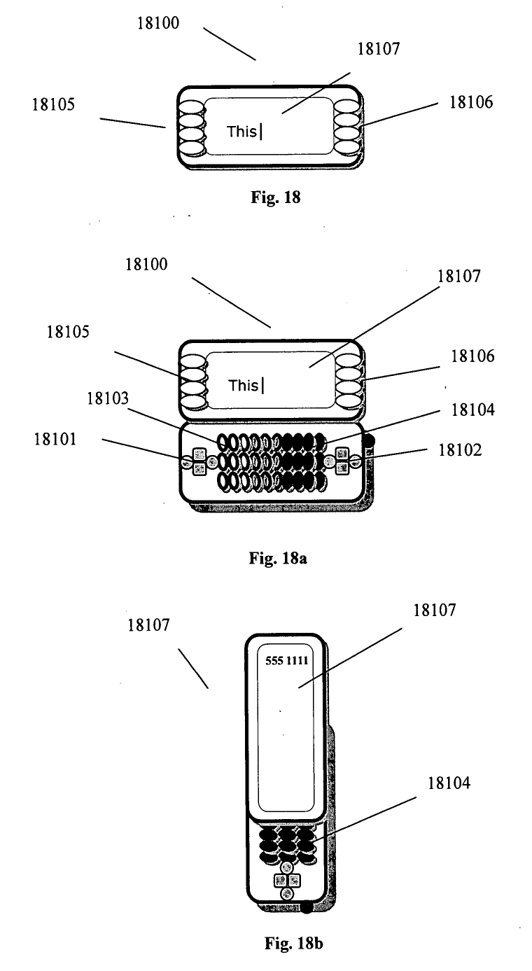

FIG. 18 shows a device such as mobile phone/data device 18100 having sets of the keys 18101, 18102 of the invention to for example duplicate the keys of the keypad of FIG. 9. Said device may be designed such that to extend in different directions for different corresponding functions.

FIG. 18a shows said device 18100, extended in landscape position, having the keys 18101, 18102 of the invention and a qwerty keyboard 18103 (e.g. used with the predictive data entry system of the invention), wherein some of said keys (also) duplicate a telephone keypad 18104. The device 18100 may be designed such that when the user desires to enter text, it may be extended and used in landscape position, and when the user desires to use it in telephone/dialing mode it may be extended and used in portrait position, as shown in FIG. 18b. Obviously the display unit 18107 of the device may change the printing direction, accordingly.

As mentioned before, the predictive data entry/correction systems of the invention using few (e.g. at least four) keys to which (e.g. four keys) substantially all of the letters of a language are distributedly assigned, may use any means for entering precise characters. As mentioned, any keyboard and method may be used for entering one or more precise characters/information-about-precise-character(s) of a word during the entry/correction of said word through the predictive data entry system of the invention. For example, said keyboard may be a telephone-type keypad and said method may be the press and speak data entry system of the invention wherein for example in order to enter a precise letter the user may presses a corresponding key and speaks said letter. In the data entry method described above, at least some of the other symbols (e.g. available on a PC keyboard) may be entered by interacting at least with the keys of the telephone-type keypad.

In the embodiment wherein any of the all of the letters of a language is precisely entered by pressing the corresponding key and speaking said letter, other symbols such as:
a first predefined type of symbol such as a digit assigned to a key may be entered by a first predefined type of interaction such as single-pressing said key without providing speech
a second predefined type of symbol such as a punctuation mark character assigned to a key may be entered by said first predefined type of interaction with said key and providing the predefined speech corresponding to said symbol
a third predefined type of symbol such as a function assigned to a key may be entered by a second predefined type of interaction with said key such as double pressing said key without providing speech
a fourth predefined type of symbol such as a command assigned to a key may be entered by a second predefined type of interaction with said key such as double pressing said key and providing the predefined speech corresponding to said symbol
and so on
and vise versa

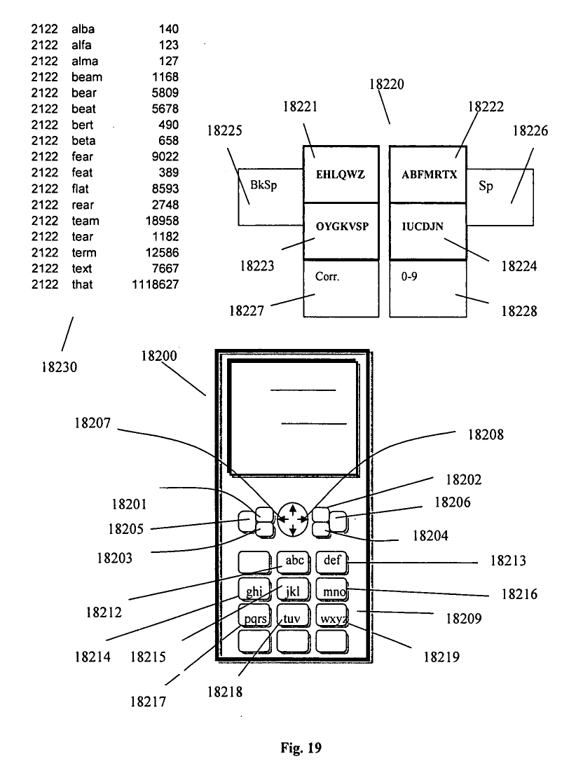

FIG. 19 shows as an example, a communication device 18200 having a keypad of the invention having (in this example) eight keys 18001-18008 duplicating the keys 18221-18228 of the exemplary keypad 18220 of the invention. In this example, the precise characters during the entry/correction of a word may be entered through the telephone-keypad 18209 by for example the press and speak data entry system of the invention. For example, by considering the portion 18230 of a dictionary of words of the system, in order to enter the word “fear”, the user may first press the key 18213 of the telephone keypad 18209 and say the letter “f” to precisely enter the letter “f”, and then press the ambiguous keys 18201, 18202, 18202 corresponding to the remaining characters “ear” of the word “fear”. By considering the (initial) input information (e.g. precise character and the ambiguous key presses), the system provides the word “fear”. According to another example, the user may first press the ambiguous keys 18202, 18201, 18202, 18202 corresponding to the characters of the word “fear” (e.g. initial information). The system may propose the word “that” having the highest priority among the words corresponding to said key presses (e.g. initial information). According to one method of correction, the user then may press (e.g. and hold) a correction key and press the key 18213 of the telephone keypad and say the letter “f” (e.g. additional information) to inform the system that the first character of the desired word must beginning with the letter “f”. The system may propose the word “fear” having the highest priority among the words corresponding to the initial and additional input information.

As mentioned before, in order to distinguish between the entry of a precise letter/character during the initial input information and during the correction procedure a different predefined (key) interaction may be used. This matter has already been described before.

As mentioned before, according to another embodiment, one of the letters assigned to a key may precisely be entered by pressing said key and speaking said letter, and any of the other letters assigned to said key may precisely be entered by pressing said key and speaking said letter. In this case, as an example:
a different predefined type of symbol such as a digit assigned to a key may be entered by a another predefined type of interaction such as pressing (and holding) a first key and single-pressing said key without providing speech (or vise versa)

As mentioned before, in this embodiment, according to one method a first letter among two letters having ambiguously resembling speech and that are assigned to (e.g. a predefined interaction with) a key may be entered by providing a predefined interaction with said key without providing speech, and the second letter among said two letters may be entered by providing said predefined interaction with said key and providing a predefined speech corresponding to said letter (e.g. speaking said letter). It must be noted that said resembling speech may be based on any of at least voice or lip-movements used to provide (any of) said speeches (e.g. used for speaking (any of) said letters).

It is understood that in this embodiment, the assignment of one of the several letters on a key to interacting with said key without providing speech and the other letters on said key to interacting with said key and providing a predefined corresponding speech may be based on other principles. For example, according to one method, the most commonly used letter on a key (“a” on key 18012, “e” on key 18213, “i” on key 18214, “s” on key 18217, “t” on key 18218, “w” on key 18219, etc.) may be assigned to a (simple) pressing action such as single pressing the corresponding key without providing a speech.

Preferably, if two (or more) of letters/characters on a key have ambiguously resembling speech relating to each other, then the letter which is assigned to (e.g. a predefined interaction with) said key without providing a speech may be the one that is more frequently used among said two (or more) letters. As a result, as an example the letter “K” on the key “5” of a telephone keypad wherein its speech in English language may ambiguously resemble to the letter “J” being on the same key (letter “K” is more often used than the letter “J”) may be assigned to pressing said key without speaking. In this examples, each of the letters “J” and “L” (e.g. although the letter “L” is more frequently used than the letter “K), may be assigned to pressing said key and speaking said letter.

With continuous reference with this embodiment, as an example, by considering the FIG. 19, in order to enter the word “fear” the user may proceed to entering initial and/or additional information as described in the previous embodiment. On the other hand, also as an example, in this embodiment in order to enter the word “alba”, the user may first press the key 18213 of the telephone keypad 18209 without speaking to precisely enter the letter “a”, and then press the ambiguous keys 18201, 18202, 18202 corresponding to the remaining characters “lba” of the word “alba”. By considering the (initial) input information (e.g. precise character and the ambiguous key presses), the system provides the word “alba”.

Obviously, based on the principles of the data entry and correction procedures of the invention as described before, said precise letter (e.g. “a” in this example) may (also) be entered during the correction procedure of the invention.

Obviously, said/the keypad/keyboard providing precise characters may have any number of keys and any type of letter attribution. For example, the letters of a language may be assigned to twelve keys of a telephone-type keypad, and the letters assigned to a key of said keypad may be assigned such that a single pressing action on said key may provides the most commonly used letter, a double pressing action on said key may provide the next most commonly used letter, and so on.

It must be noted that, although, in different embodiments different keypads such as a telephone-type keypad or a keypad having at least four keys wherein to four of the keys at least substantially all of the letters of a language are assigned, have been used to demonstrate the principles of different embodiments of the invention, obviously, any other kind of keypad having any number of keys wherein at least some of the keys of the keypad are/maybe ambiguous, any type of keys such as hard or soft keys, any configurations of symbols assigned to any predefined type of interaction with the keys of the keypad, etc., may be used with the embodiments of the combined (e.g. including the predictive) data entry systems of the invention. For example, if the predictive data entry system of the invention uses a telephone-type keypad in English language, according to one embodiment, the user may use its eight ambiguous letter keys to enter a word through the predictive data entry systems of the invention, during which (e.g. entry/correction) he may enter one or more precise character/letter of said word by pressing the corresponding key and speaking (e.g. or other interaction such as pressing a first predefined (e.g. “mode/correction”) key and multi-pressing on the corresponding key, to avoid the use of speech) said character/letter. The user may also use one of the (e.g. other) keys of said keypad for the correction procedure(s) of the invention as described in this and other patent applications filed by this inventor. Obviously, the correction methods of the data entry system of the invention may also apply with using of the telephone-type keypad. For example, according to one method a (e.g. another) key such as the “1” key of the telephone type keypad may be used as the “mode/correction” key and be used with the correction procedures of the invention as described in this and other patent applications filed by this inventor. As an example, by considering a telephone keypad resembling to the telephone keypad 18009 of FIG. 17, after pressing the keys (e.g. the initial input information) corresponding to the word “ball”, the system may propose the corresponding word “call” having higher priority. As an example, the user may provide additional input information through the correction procedure of the invention by pressing a predefined correction key 18019 and speak/say the letter “b”. The system, then, may propose the word “ball” corresponding to the initial and additional input information provided by the user. These matters have already been described in detail previously.

Although in many paragraphs describing the combined data entry systems of the invention, “keys” have been used to describe the embodiments, it is understood that other input means used by predefined types of interactions to provide different predefined input signals, may be considered to duplicate/replace the keys and key interactions in the embodiments of the invention. For example, use's interactions such as finger or finger cap interactions and corresponding interactions and other means such as stylus, glove, etc., duplicating the keys and key interactions as described in this and the references incorporated herein, filed by this inventor, may be used in the embodiments.

Note that in some paragraphs the term “pressing” have been used as an example of a type of interaction with a key. Said interaction may be any other type of predefined key interaction, or any other type of interaction such as touching/gliding/pointing-to, etc, with a key.

It must be noted that although in many paragraphs a keypad (e.g. or few keys) have been used to demonstrate an embodiment of the combined (e.g. including predictive) data entry systems of the invention, it is understood that the keypad may generally having some ambiguous keys (e.g. an ambiguous key have been described before).

For not frequently repeating the principles of the data entry systems of the invention, in many paragraphs of this application there is mentioned that one or more symbol such as character/word/portion-of-a-word/function, etc., may be assigned to a key (e.g. or an input object other than a key). It is understood that said symbols, generally, are intended to generally be assigned to simplest interactions in the corresponding embodiment based on principles of the data entry systems of the invention as explained in many paragraphs.

Although in different embodiments of the invention, a voice recognition system (e.g. having a microphone, may have been mentioned to be used to perceive and recognize a user's speech, a lip-reading system (e.g. having a camera), may be used instead-of or in-addition-to the voice recognition system to perceive and recognize the user's speech (or vise versa). As mentioned before, different methods/means of detecting user's speech such as using means for detecting user's speech provided by means such as user's voice or lip movements may be used by the system. For example, in addition-to or in replacement-of a traditional microphone, an ear/bone microphone detecting user's voice based on user's (e.g. ear) bone vibrations when providing speech may be used with the system (e.g. the principles of an ear/bone microphones are known by the people skilled in the art). It must be noted that each of said means of detecting user's speech may be used separately, or at least some of them may be combined.

Also as mentioned before, some or all of the methods of the data entry systems of the invention may use linguistically rules text entry recognition systems such as the number of a syllable of possibly-matched word, the number of words of a possibly-recognized sentence, the position of a word within a phrase, word-completion systems, etc. These matters are known by the people skilled in the art.

It must be noted that in some paragraphs the term “portion-by-portion” have been used for simplifying the term “at-least-a-portion-of-a-word (e.g. by at-least-a-portion-of-a-word”.

Note that, although for simplifying reason, in many paragraphs, the data entry systems of the invention is mentioned in a phrase such as “data entry systems of the invention”, “pressing/gliding data entry systems of the invention”, “press/glide-and-speak data entry systems of the invention”, etc., it is understood that as described in detail in many paragraphs, such phrases refer to the principles of the data entry systems of the invention considering the pressing/gliding actions that according to several embodiments maybe/are combined with user's speech information, wherein the speech information is the presence of corresponding speech or in the absence of user's speech (e.g. wherein the systems are generally used with the combined data entry systems of the invention when during the entry of a word at least one precise character of the word is entered through the referred systems and wherein at least one of the key presses provided for the entry of the word is ambiguous). These matters have already been described in detail. Also, in many paragraphs, the data entry systems of the invention combining the press/glide-and speak data entry systems of the invention and the word predictive data entry systems such as the ones of the invention, may have been mentioned in a phrase such as “combined” data entry systems of the invention”.

Note that although in many embodiments of the data entry systems of the invention a sensitive surface such as a touch-sensitive pad or a touch screen have been used as examples, it is understood that any other technology detecting and analyzing a user's interaction with any surface may be used to define and/or use the zone/keys of a soft (e.g. dynamic) keypad. For example, as mentioned, the technology may be an optically detecting technology, or an IR technology providing a virtual keypad (e.g. having few keys/zones wherein for example, to 4 keys/zones of the keypad at least substantially all of the letters of a language are assigned) on a (normal) surface and detects the user's finger touching the keys/zones of the keypad.

Also, it must be noted that according to one method, while user enters a word by using the predictive system of the combined data entry systems of the invention, the system may print the most probable word corresponding to the input information provided by the user until that moment (e.g. before providing an end-of-a-word-signal). It is understood that the displayed word may change each time a user presses an additional key corresponding to the word. According to one embodiment of the invention, the word predictive system of the invention does not propose an ambiguous word corresponding to the user's information (e.g. ambiguous key presses, and unambiguous information such as (key press and) speech, handwriting, etc.) until an end-of-the-word signal such as a space character is provided at the end of said input information.

Obviously, all or part of the principles of the embodiments of this invention and other inventions of this inventor and/or their features may be used separately or being combined together. For example, at-least-one-word/at-least-part-of-a-word of a text may be entered by combining different methods or embodiments of the data entry systems of the invention. For example, tapping/gliding actions on a sensitive surface as described in the references incorporated herein, filed by this inventor (e.g. such as tapping and/or gliding actions provided by user's finger, a pen, a glove, etc., duplicating, for example, interactions with few keys such as with at least four keys of a keypad wherein at least the letters of a language are assigned to few predefined keys such as four keys of the keys as described in detail in this application and the references incorporated herein, filed by this inventor, the glove of the data entry systems of the inventions also duplicating the keys, and different additional interactions for entering precise characters such as user's speech, full keyboard, handwriting and recognition, etc, as described in this application and in the references incorporated herein, filed by this inventor, etc.), may be used with the predictive data entry systems of the invention.

It must be noted that although in many examples, the input information provided for the entry of a word is mentioned as being based on key presses, it is understood that, if desired/permitted, in addition to a key press (e.g. for better accuracy), the user may also provide other additional means such as the speech, keys of a full keyboard, etc., corresponding to at least some of the corresponding key presses and/or characters of the desired word.

It must be noted that although in many paragraphs describing the methods of data entry system of the invention, the input information provided by the user is mentioned as may being correspond to a character of a word, obviously, depending on the architecture of the system, in some cases the input information may correspond to a chain of characters of the corresponding word (e.g. see the portion-of-a-word data entry systems of the invention). Obviously, as mentioned previously in detail, the character date entry systems of the invention combined with portion-of-a-word data entry systems of the invention may be used with the (e.g. word) predictive data entry systems of the invention. For example, to enter the word “action”, the user may first press the keys corresponding to the letters “a” and “c”, and then provide a gliding action on the key that are predefined to represent the portion-of-a-word “tion”, and speak the portion (e.g. saying “shen”). Based on the input information provided by the user, the predictive data entry system of the invention may, for example, look for a word wherein its two beginning characters correspond to the two key presses and that the remaining characters of the word is the chain of characters “tion”. The system may consider the word “action”, and depending on its frequency of use, the system may propose the word to the user. In the example above, the user could also precisely enter any of the characters “a” or “c” by speaking the letter (e.g. while pressing the corresponding key) to help the system/user to for example, faster/more accurately provide the desired word.

Using the combined character and portion-of-a-word data entry systems of the invention with the productive data entry systems of the invention to enter and/or correct/replace a proposed word by the system has been previously described in detail. As described before, such systems may include/work-with at least one data entry system such as an on-screen full keyboard or handwriting input/recognition system to replace or in addition to speech recognition system to enter precise characters that may correspond to at least a letter or a portion of a word. The precise character(s) and additional input information such as ambiguous key presses corresponding to the characters of a word, may be considered by the predictive data entry systems of the invention to provide the desired word.

Also for example, the combined data entry systems of the invention may be used/implemented-with (e.g. for example, by using a split keypad of the invention) an extendable computer such as shown (e.g. see FIGS. 70a to 70h and the corresponding description in the incorporated PCT/US04/12082.

It must again be noted that depending on the architecture of the system, the portion-of-a-words of a language may either be included within the dictionary of words database of the language or they may constitute a separate database and be used with the combine (e.g. including the predictive) data entry systems of the invention.

It must be noted that speech information corresponding to a letter is generally speaking the letter.

It must also be noted that key press(es) corresponding to at least one character of a word generally means providing the sequence of key presses corresponding to (sequentially) to the characters.

It must be noted that as described in detail above, providing a predefined interaction with a key may also refer to providing a press-and-holding action on another key and providing a pressing action on the key (or vise versa).

It must again be noted that although in many paragraphs describing the methods/features of invention key press information have been mentioned for the entry of a word, obviously said methods/features, may consider other input information such as the corresponding speech may be provided by the user, in addition to or in replacement of said key press information.

Thus, while there have been shown and described and pointed out fundamental novel features of the invention as applied to alternative embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto. It is to be understood that the drawings are not necessarily drawn to scale, but that they are merely conceptual in nature.

In the correction procedures of the invention, when the user presses the correction key without providing speech, although preferably the system may be designed such that to propose the next word corresponding to the user's (e.g. combined) input information and having the next highest priority, obviously, the system may be designed differently such to provide a next word corresponding to the user's input information and combined with other principles such as
the context of the sentence/text, or
the alphabetical older, or
other(s)

It must be noted that although in many paragraphs a pressing action on a key is mentioned to explain/demonstrate an interaction with said key, obviously, said pressing action, obviously, as mentioned in many embodiments, said pressing action may be of any type such as:
a single/double/more pressing/gliding action on said key
a single/double/more pressing/gliding action on another key, and a single/double/more pressing/gliding action on said key (or vise versa), simultaneously or none-simultaneously
a single/double/more pressing/gliding-and-holding action on another key, and a single/double/more pressing/gliding action on said key (or vise versa)
etc.

It must be noted the combination of such interactions may be so numerous that it may not be possible to explain them all without making the patent application long. To make it short, it must be noted that such combinations may be obvious by people skilled in the art.

Also obviously, the interactions for entry/selection of a precise character during the entry and/or correction procedure for the entry of said word, may be such that explaining the of the possibilities may make the patent description too long.

As an example, by considering the elements of the FIG. 13, by using the predictive data entry system of the invention, after proposing a non-desired word by the system based on the initial input information provided to the user, during the correction procedure for the entry of the desired word:
according to one method, the user may press (e.g. and preferably hold) a correction key, and enter the (beginning) character(s)/letter(s) of the desired word by pressing the desired key of the full keyboard or by speaking the desired letter. The system may propose a word corresponding to the combined initial and additional input information. if the new proposed word still is not the desired word, then the user may provide a predefined interaction such as a single-pressing action on the correction key to scroll to the next word corresponding to said initial and additional input information, and repeat it if the next proposed word is still a none-desired one, and so on.
according to another method, the user may provide a predefined interaction such as a predefined pressing action with at least one predefined key, such as press-and-holding action on a first (e.g. mode) key, and press the desired key of the full keyboard or speak the desired letter to input/select said letter. The system may propose a word corresponding to the combined initial and additional information provided by the user. if the new proposed word still is not the desired word, then (e.g. if needed, while pressing-and-holding the/a first/mode key) the user may provide a predefined interaction such as a predefined pressing action with/on a predefined key, such as a single-pressing action on a correction key to scroll to the next word corresponding to said initial and additional input information provided by the user, and repeat it if the next proposed word is still a none-desired one, and so on.

It must again be noted the combination of such interactions may be so much that it may not be possible to explain them all without making the patent application long. To make it short, it must be noted that such combinations may be obvious by people skilled in the art.

It must also be noted that although the term “mode” (e.g. of other terms) has been used to describe an interaction with a key, obviously, generally, said (specific) term(s) have been used to simplify the description of the corresponding embodiments. Obviously, because the system uses few keys, each key is generally used for more than one symbol such as character or function. Therefore, if for example, the term of pressing a “mode key” is used somewhere in the patent application, it generally refers to a key through which said function may be provided through a predefined interaction with said key.

According to one embodiment of the invention, the press-and-speak (e.g. including word predictive) data entry system of the invention using speech recognition such as at least both voice recognition and lip reading systems, may use a keypad of the inventions such that the characters, such as at least the letters, assigned to few (e.g. four) keys of said keypad being assigned to said keys such that letters/characters that have ambiguous resembling speech relating to each other through a first method of recognition (e.g. voice) and/but do not have ambiguously resembling speech through the second recognition method (e.g. lip reading) (e.g. or vise versa), may be assigned to a same key and/or to a same predefined interaction with said key) so that when the user presses the corresponding key (or provides the corresponding key interaction) and speaks any of said characters/letters, the system may recognize said ambiguous letter/character by at least one of said (speech) recognition systems. Obviously, based on principles of the press-and-speak data entry systems of the inventor, as described in different patent applications filed by this inventor, preferably characters/letters that have ambiguously resembling speech relating to each other (e.g. in this example, through both methods of speech recognition (e.g. voice recognition, lip reading/recognition), may be assigned to different keys and/or to a different predefined interaction with a same key.

It must be noted that the arrangement of database of words and the fields corresponding to each word demonstrated in different drawings and corresponding descriptions are shown as examples only. Obviously, the database of words of the invention may have different fields and be arranged differently to for example enhance the search and sort of the words of the database.

It must be noted that the systems described for entering precise characters are mentioned only as example for demonstrating the principles of the predictive data entry systems of the invention (e.g. entering words based on pressing ambiguous keys, and if needed entering (the information corresponding to) at least one precise character of the word). It is understood that many other methods and derivatives based on principles of the invention and the demonstrated methods, may be considered by those skilled in the art for entering precise characters and using them during the entry/correction of a word through the predictive data entry systems of the invention.

What is claimed is:

1. A data entry system comprising:
a plurality of a first type of input means, such as keys, to provide input signals to which symbols, such at least the letters of the alphabet of at least one language, are distributively assigned, and such that at least two of said letters are assigned to at least one of said input means, and wherein pressing a key may provide a first input information that ambiguously correspond to any of said letters; and
a second input information for supporting either one of the following procedures;
using a second type of input means for entering unambiguous letters;
providing additional information corresponding to a letter assigned to said key that is being pressed so that to help the system to select said letter among the symbols that are assigned to said input signal;
wherein said data entry system supports at least one database of words such that in order to enter a desired word of said at least one database, a user of said system employs an entry method selected from the group consisting of:
a first method including combined information corresponding to said word, wherein said combined information includes providing said first input signals such as key presses corresponding to at least some of the characters of said word and providing said second input information to enter precisely at least one character such as a letter of said word through said procedure of input; and
a second method including providing the input signals such as key presses corresponding to substantially all of the characters of said word without providing said additional information.

2. A data entry system as claimed in claim 1, wherein the system compares the information provided through said method with the corresponding information corresponding to the words of said database and proposes a corresponding word, and wherein if the word proposed by the system is not the word desired by the user, then the user may proceed to at least any of the following correction procedures to provide more information to the system, corresponding to the desired word such that
a first correction procedure includes the steps of:
if the proposed word begins with the same letter as that of the desired word, then the user presses a predefined key such as a “Next” key and the system proposes the next word of the database corresponding to the combined input information provided by the user and that begins with the same letter as the proposed word;
if the proposed word does not begin with the same letter as the desired word, then the user provides information corresponding to the first character of the desired word such that the system recognizes said character and propose a word corresponding to the combined input information provided by the user and that begins with said letter;
and a second correction procedure includes the steps of:
the user provides information corresponding to the first character of the desired word such that the system recognizes said character and propose a word corresponding to the combined input information provided by the user wherein said word begins with said letter.

3. The system as claimed in claim 1, wherein said second type of input means is a standard PC keyboard or a keypad wherein pressing a key provides a precise character such as letter.

4. The system as claimed in claim 1, wherein said means for entering an unambiguous letter is handwriting and recognition system.

5. The system as claimed in claim 1, wherein said additional information is speaking said letter.
